(19) United States
(12) Patent Application Publication
(10) Pub. No.: US 2024/0394598 A1
(43) Pub. Date: Nov. 28, 2024

(54) APPARATUS, SYSTEM, AND METHOD OF TRAINING A MACHINE LEARNING (ML) MODEL

(71) Applicant: MobilEye Vision Technologies Ltd., Jerusalem (IL)

(72) Inventors: Etay Zvi Livne, Bat Yam (IL); Gal Kaplun, Jerusalem (IL); Eran Malach, Jerusalem (IL); Shai Shalev-Shwartz, Jerusalem (IL)

(73) Assignee: MobilEye Vision Technologies Ltd., Jerusalem (IL)

(21) Appl. No.: 18/666,306

(22) Filed: May 16, 2024

Related U.S. Application Data
(60) Provisional application No. 63/502,705, filed on May 17, 2023.
(60) Provisional application No. 63/515,233, filed on Jul. 24, 2023.

(51) Int. Cl. G06N 20/00

(52) U.S. Cl. CPC G06N 20/00

(57) ABSTRACT

For example, a Machine-Learning (ML) model training system may be configured to shuffle a plurality of input examples in plurality of input blocks to provide a plurality of first-shuffled examples in a plurality of shuffled blocks; and to provide the plurality of first-shuffled examples in the plurality of shuffled blocks as an input to a model training procedure to train an ML model. For example, the model training procedure may include a plurality of epoch iterations applied to a plurality of block groups. For example, an epoch iteration may include determining a block group for the epoch iteration by randomly selecting a group of shuffled blocks from the plurality of shuffled blocks; shuffling first-shuffled examples in the block group to provide a plurality of second-shuffled examples; and updating the ML model according to a plurality of update iterations applied to the plurality of second-shuffled examples.

### CROSS REFERENCE

This application claims the benefit of, and priority from, U.S. Provisional Patent Application No. 63/502,705 entitled “APPARATUS, SYSTEM, AND METHOD OF DATA SHUFFLING”, filed May 17, 2023, and U.S. Provisional Patent Application No. 63/515,233 entitled “APPARATUS, SYSTEM, AND METHOD OF DATA SHUFFLING”, filed Jul. 24, 2023, the entire disclosures of which are incorporated herein by reference.

### BACKGROUND

There are various techniques for training Machine Learning (ML) models.

For example, a Stochastic gradient descent (SGD) technique may be implemented for minimizing an objective function of an ML model.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of operations according to a Machine Learning (ML) model training technique, in accordance with some demonstrative aspects.

FIG. 3 is a schematic illustration of graphs depicting simulation results of a data distribution according to a dual-shuffling technique compared to data distributions according to a single-shuffling technique and a full-shuffling technique, in accordance with some demonstrative aspects.

FIGS. 4-11 are schematic illustrations of graphs depicting simulation results of a performance of a dual-shuffling technique compared to performances of a single-shuffling technique and a full-shuffling technique, in accordance with some demonstrative aspects.

FIG. 12 is a schematic flow-chart illustration of a method of ML model training, in accordance with some demonstrative aspects.

FIG. 13 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities capture the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects, for example, may capture the form of an entirely hardware aspect, an entirely software aspect, or an aspect including both hardware and software elements. Some aspects may be implemented in software, which includes but is not limited to firmware, resident software, microcode, or the like.

Furthermore, some aspects may capture the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some demonstrative aspects, the medium may be an electronic, magnetic, optical, electromagnetic, infrared, or semiconductor system (or apparatus or device) or a propagation medium.

In some demonstrative aspects, a data processing system suitable for storing and/or executing program code may include at least one processor coupled, directly or indirectly, to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some demonstrative aspects, input/output or I/O devices (including but not limited to keyboards, displays, pointing devices, etc.) may be coupled to the system either directly or through intervening I/O controllers. In some demonstrative aspects, network adapters may be coupled to the system to enable the data processing system to become coupled to other data processing systems or remote printers or storage devices, for example, through intervening private or public networks. In some demonstrative aspects, modems, cable modems and Ethernet cards are demonstrative examples of types of network adapters. Other suitable components may be used.

Some aspects may include one or more wired or wireless links, may utilize one or more components of wireless communication, may utilize one or more methods or protocols of wireless communication, or the like. Some aspects may utilize wired communication and/or wireless communication.

Some aspects may be implemented by one or more elements of a computing system including one or more computing devices.

For example, a computing system may be implemented using suitable hardware components and/or software components, for example, processors, controllers, memory units, storage units, input units, output units, communication units, operating systems, applications, or the like.

In some demonstrative aspects, the computing system may include, for example, one or more of a processor, an input unit, an output unit, a memory unit, and/or a storage unit. The computing device may optionally include other suitable hardware components and/or software components. In some demonstrative aspects, some or all of the components of one or more of the computing device may be enclosed in a common housing or packaging, and may be interconnected or operably associated using one or more wired or wireless links. In other aspects, components of the computing device may be distributed among multiple or separate devices.

In some demonstrative aspects, the processor may include, for example, a Central Processing Unit (CPU), a Graphics Processing Unit (GPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller.

In some demonstrative aspects, the input unit may include, for example, a keyboard, a keypad, a mouse, a touch-screen, a touch-pad, a track-ball, a stylus, a microphone, or other suitable pointing device or input device. The output unit may include, for example, a monitor, a screen, a touch-screen, a Light Emitting Diode (LED) display unit, a flat panel display, a Liquid Crystal Display (LCD) display unit, a plasma display unit, one or more audio speakers or earphones, or other suitable output devices.

In some demonstrative aspects, the memory unit may include, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. The storage unit may include, for example, a hard disk drive, a Solid State Drive (SSD), or other suitable removable or non-removable storage units. For example, the memory unit and/or the storage unit, for example, may store data processed by the computing device.

In some demonstrative aspects, the computing system may be configured to communicate with one or more other devices via a wireless and/or wired network.

In some demonstrative aspects, the computing system may be configured to perform and/or to execute one or more operations, modules, processes, procedures, and/or the like, e.g., as described below.

In some demonstrative aspects, the computing system may include at least one application, which may be implemented by, as part of, and/or in the form of, at least one service, module, and/or controller, e.g., as described below.

In some demonstrative aspects, the application may include, or may be implemented as, software, a software module, an application, a program, a subroutine, instructions, an instruction set, computing code, words, values, symbols, and/or the like.

In some demonstrative aspects, the application may include a local application to be executed by a computing device.

In some demonstrative aspects, the memory unit and/or storage unit of the computing device may store instructions resulting in the application, and/or the processor may be configured to execute the instructions resulting in the application and/or to perform one or more calculations and/or processes of the application, e.g., as described below.

In other aspects, the application may include a remote application to be executed by a suitable computing system, e.g., a server.

In some demonstrative aspects, the server may include at least a remote server, a web-based server, a cloud server, and/or any other server.

In some demonstrative aspects, the computing device may communicate with the server, for example, via the network.

In some demonstrative aspects, the server may include a suitable memory and/or storage unit having stored thereon instructions resulting in the application, and a suitable processor to execute the instructions.

In some demonstrative aspects, the application may include a combination of a remote application and a local application.

In one example, the application may be downloaded and/or received by the computing device from another computing system, e.g., the server, such that the application may be executed locally by the computing device. For example, some or all of the instructions of the application may be received and stored, e.g., temporarily, in a memory or any suitable short-term memory or buffer of the computing device, e.g., prior to being executed by the processor of the computing device.

In another example, the application may include a front-end to be executed locally by the computing device, and a backend to be executed by the server. For example, the front end may include and/or may be implemented as a local application, a web application, a web site, a web client, or the like.

For example, one or more first operations of the application may be performed locally, for example, by the computing device, and/or one or more second operations of the application may be performed remotely, for example, by the server.

In other aspects, the application may include and/or may be implemented by any other suitable computing arrangement and/or scheme.

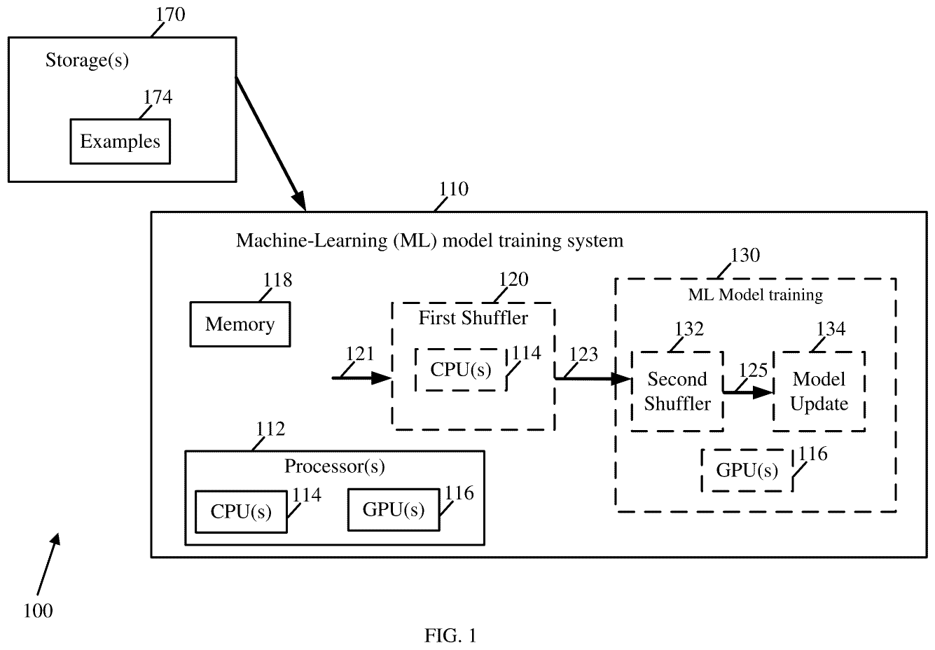

Reference is made to FIG. 1, which schematically illustrates a system 100, in accordance with some demonstrative aspects.

In some demonstrative aspects, system 100 may include a Machine Learning (ML) model training system 110, which may be configured to train a ML model, e.g., as described below.

In some demonstrative aspects, ML model training system 110 may be configured to train the ML model based on a plurality of examples (also referred to as “samples”) 174, which may be retrieved from one or more storages 170.

In some demonstrative aspects, the one or more storages 170 may include one or more local storages, which may be commonly located with the ML model training system 110.

In some demonstrative aspects, the one or more storages 170 may include one or more remote storages, which may be remotely located, e.g., at one or more locations different from the location of the ML model training system 110.

In some demonstrative aspects, the one or more storages 170 may include one or more Databases (DBs), cloud storages, storage devices, memory devices, or the like.

In some demonstrative aspects, ML model training system 110 may be configured to train the ML model, for example, according to a Stochastic Gradient Descent (SGD) training procedure, e.g., as described below.

In other aspects, ML model training system 110 may be configured to train the ML model based on any other additional or alternative training procedure.

In some demonstrative aspects, ML model training system 110 may be configured to provide a technical solution to address one or more technical aspects of a training procedure, which may be based on a randomness of examples of a data set to be provided to the training procedure, e.g., as described below.

In some demonstrative aspects, ML model training system 110 may be configured to provide a technical solution to provide a technical solution to increase a level of randomness of examples of a data set to be provided to the training procedure, e.g., as described below.

For example, when using some types of training procedures, e.g., an SGD training procedure, for training a ML model, it may be important, e.g., even crucial, to provide the ML model with examples, which are sampled at random from the dataset.

In some demonstrative aspects, ML model training system 110 may be configured to provide a technical solution to increase a level of randomness of examples of a data set to be provided to the training procedure, for example, in use cases where random access to individual examples may be costly and/or inefficient e.g., as described below.

For example, in case of implementing large datasets, which are remotely stored, e.g., in the cloud, random access to individual examples may often be costly and/or inefficient.

For example, in some use cases, deployments, and/or implementations, machine learning pipelines, which may be used for training large neural network models, may require extensive datasets, which may frequently be stored on cloud-based systems, e.g., due to their size. These technical setting may surpass the capacity of fast memory access.

For example, training procedures, e.g., SGD-based procedures, may be implemented as optimization tools for this type of use cases.

For example, the training procedures, e.g., the SGD-based procedures, may be based on Independent and Identically Distributed (i.i.d), or close to i.i.d, access to the dataset, which may be advantageous, for example, in case random access memory is available.

However, in some use cases, scenarios, deployments, and/or implementations, random memory access may be inefficient, costly, or even unavailable. For example, when utilizing relatively slow storage systems, e.g., cloud-based storages, random access may be costly. For example, in such cases it may be preferable to sequentially read and/or write data from/to the storage.

For example, in some use cases, scenarios, deployments, and/or implementations, the challenge of random access may be compounded by the arrangement of the dataset examples in the storage.

For example, in many implementations it may be customary to store data in shards, which may include horizontal (row-wise) partitions of the data. For example, a partition, e.g., each partition, may be maintained on a separate server or storage system, e.g., to efficiently distribute load. In one example, image data may often be acquired in the form of videos, leading to the storage of single or multiple clips within each shard. This arrangement of the data may result in highly homogeneous and/or non-diverse chunks of data. As a result, executing an SGD-based procedure with sequential reading of examples, e.g., without randomized access, may result in a suboptimal training results.

In some demonstrative aspects, for example, in some use cases, scenarios, deployments, and/or implementations, there may be one or more technical issues in performing a full shuffling of the data set, for example, prior to performing the SGD-based procedure. For example, a full shuffle of the dataset may also require random access to the full memory storing the dataset. For example, the procedure of SGD with i.i.d data access may be simulated by fully shuffling the dataset “offline” (before training), and reading the data sequentially “online” (during training). This procedure may have a convergence rate of training comparable to that of random access SGD. However, this procedure may require a lengthy and expensive offline phase.

For example, it has been proposed to solve these technical issues by performing a partial shuffle (“online shuffle”), for example, during training time.

For example, it has been proposed to perform a shuffling algorithm (also referred to as “the CorgiPile algorithm”), which may be utilized to read multiple shards into a large memory buffer, to shuffle the buffer, and to use the partially shuffled examples for training. This approach may provide a technical solution to gain data access efficiency, e.g., at the expense of performance loss, which may be especially noticeable for large datasets stored in homogeneous shards, e.g., video datasets.

In some demonstrative aspects, ML model training system 110 may be configured to perform one or more operations and/or functionalities of a data shuffling technique, which may be configured to shuffle the examples 174 for the model training procedure, e.g., as described below.

In some demonstrative aspects, ML model training system 110 may be configured to perform one or more operations and/or functionalities of a data shuffling technique, which may be configured as a storage-aware data shuffling technique, e.g., as described below.

In some demonstrative aspects, ML model training system 110 may be configured to perform one or more operations and/or functionalities of a data shuffling technique, which may be configured to provide a technical solution to support training the ML model with improved performance and/or efficiency, e.g., as described below.

In some demonstrative aspects, ML model training system 110 may be configured to perform one or more operations and/or functionalities of a data shuffling technique, which may be configured to provide a technical solution to support training the ML model according to an SGD-based training procedure, e.g., as described below.

In some demonstrative aspects, ML model training system 110 may be configured to perform one or more operations and/or functionalities of a two-stage data shuffling technique (also referred to as “dual-shuffling technique” or “Corgi² technique”), which may include a first shuffling and a second shuffling, e.g., as described below.

In some demonstrative aspects, the dual-shuffling technique may be configured as a hybrid shuffling technique (also referred to as “hybrid offline-online shuffling”), which may include performing the first shuffling prior to the training procedure (offline shuffling), and performing the second shuffling during the training procedure (online shuffling), e.g., as described below.

In some demonstrative aspects, the Corgi² technique may be configured to provide a technical solution to enjoy the strengths of both offline data shuffling techniques as well as online data shuffling techniques, e.g., as described below.

In some demonstrative aspects, the dual-shuffling technique may be implemented according to a two-step partial data shuffling strategy for SGD, which may combine an offline shuffling iteration, e.g., including one or more operations based on the CorgiPile algorithm, which may be combined with a subsequent online iteration, e.g., including one or more operations based on the CorgiPile algorithm.

In some demonstrative aspects, the dual-shuffling technique may be configured to provide a technical solution having an improved trade-off between data access efficiency and optimization performance, e.g., as described below.

In some demonstrative aspects, the dual-shuffling technique may be configured to provide a technical solution, which may “enjoy the best of both worlds”, e.g., in terms of performance and data access efficiency, e.g., as described below.

For example, the dual-shuffling technique may be configured to provide a technical solution to support a relatively high performance, e.g., similar to an SGD-based procedure with random access, for example, even in case of substantially homogenous data, e.g., as described below.

For example, the dual-shuffling technique may be configured to provide a technical solution to support a performance similar to an SGD-based procedure with random access, for example, without substantially compromising data access efficiency, e.g., compared to the CorgiPile algorithm, e.g., as described below.

In some demonstrative aspects, the Corgi² technique may be configured to include the first shuffling, for example, as an offline stage, e.g., which may be configured to incur a relatively small overhead, e.g., compared to the second shuffling.

In some demonstrative aspects, the first shuffling may be configured to provide a technical solution to support partial shuffling of the dataset, for example, with a high level of efficiency in terms of memory access efficiency, for example, compared to a full offline shuffle, e.g., as described below.

In some demonstrative aspects, the dual-shuffling technique may be configured to provide a technical solution to achieve improved performance, e.g., comparable to SGD with random access, e.g., even for homogeneous data, for example, without substantially compromising on data access efficiency, e.g., as described below.

In some demonstrative aspects, the dual-shuffling technique may be configured to provide a technical solution to improve the way of training machine learning models in storage-aware systems, e.g., as described below.

In some demonstrative aspects, ML model training system 110 may include one or more processors 112, and one or more memories 118.

In some demonstrative aspects, the one or more processors 112 may include one or more CPUs 114, and/or one or more GPUs 116, e.g., as described below. In other aspects, the one or more processors 112 may include any other additional or alternative suitable types of processors.

In some demonstrative aspects, the one or more processors 112 may be configured to execute instructions stored by the one or more memories 118, e.g., as described below.

In some demonstrative aspects, the one or more memories 118 may store instructions, which, when executed by the one or more processors 112, may enable the one or more processors 112 to cause ML model training system 110 to train an ML model, e.g., as described below.

In some demonstrative aspects, the one or more memories 118 may store information processed by the one or more processors 112, e.g., during the training of the ML model, e.g., as described below.

In some demonstrative aspects, the one or more processors 112 may be configured to retrieve the examples 174 from the one or more storages 170.

In some demonstrative aspects, the one or more processors 112 may be configured to shuffle the examples 174 according to a dual-shuffling technique including a first data shuffling and a second data shuffling, e.g., as described below.

In some demonstrative aspects, the one or more processors 112 may be configured to perform the functionality of a first data shuffler 120 to perform the first shuffling, e.g., as described below.

In some demonstrative aspects, one or more, e.g., some or all, operations and/or functionalities of the first data shuffler 120 may be performed by one or more CPUs 114. In other aspects, any other additional or alternative processors 112 may be utilized.

In some demonstrative aspects, the one or more processors 112 may be configured to perform the functionality of ML model training procedure 130 to train the ML model, e.g., as described below.

In some demonstrative aspects, one or more, e.g., some or all, operations and/or functionalities of the ML model training procedure 130 may be performed by one or more GPUs 116. In other aspects, any other additional or alternative processors 112 may be utilized.

In some demonstrative aspects, the first data shuffler 120 may be configured to perform the first shuffling, for example, prior to performing the ML model training procedure 130 to train the ML model, e.g., as described below.

In some demonstrative aspects, the one or more processors 112 may be configured to perform the functionality of a second data shuffler 132 to perform the second shuffling, e.g., as described below.

In some demonstrative aspects, the second data shuffler 132 may be configured to perform the second shuffling, for example, during the ML model training procedure 130 to train the ML model, e.g., as described below.

In some demonstrative aspects, one or more, e.g., some or all, operations and/or functionalities of the second data shuffler 132 may be performed by one or more GPUs 116. In other aspects, any other additional or alternative processors 112 may be utilized.

In some demonstrative aspects, the first data shuffler 120 may be configured to shuffle a plurality of input examples 121 in plurality of input blocks, for example, to provide a plurality of first-shuffled examples 123 in a plurality of shuffled blocks, e.g., as described below.

In some demonstrative aspects, a count of shuffled blocks in the plurality of shuffled blocks may be equal to a count of input blocks in the plurality of input blocks, e.g., as described below. In other aspects, any other count of shuffled blocks may be implemented.

In some demonstrative aspects, the one or more processors 112 may be configured to sequentially retrieve the plurality of input blocks 121 from at least one storage 170.

In some demonstrative aspects, the first data shuffler 120 may be configured to provide the plurality of first-shuffled examples 123 in the plurality of shuffled blocks as an input to the ML model training procedure 130 to train the ML model, e.g., as described below.

In some demonstrative aspects, the ML model training procedure 130 may include a plurality of epoch iterations, which may be applied, for example, to a plurality of block groups, e.g., as described below.

In some demonstrative aspects, an epoch iteration of the plurality of epoch iterations may include determining a block group for the epoch iteration, for example, by randomly selecting a group of shuffled blocks from the plurality of shuffled blocks, e.g., as described below.

In some demonstrative aspects, the epoch iteration may include shuffling first-shuffled examples 123 in the block group, for example, to provide a plurality of second-shuffled examples 125, e.g., as described below.

In some demonstrative aspects, the second shuffler 132 may be configured to determine the block group for the epoch iteration, and to shuffle the first-shuffled examples 123 in the block group to provide the plurality of second-shuffled examples 125, e.g., as described below.

In some demonstrative aspects, the epoch iteration may include updating the ML model, for example, according to a plurality of update iterations applied to the plurality of second-shuffled examples 125, e.g., as described below.

In some demonstrative aspects, the one or more processors 112 may be configured to perform the functionality of a model update procedure 134, for example, to update the ML model, for example, the plurality of second-shuffled examples 125, e.g., as described below.

In some demonstrative aspects, the one or more processors 112 may be configured to perform a before-training shuffling to provide the plurality of first-shuffled examples 123 in the plurality of shuffled blocks, e.g., as described below.

In some demonstrative aspects, the one or more processors 112 may be configured to perform a during-training shuffling of the plurality of first-shuffled examples 123, for example, during the ML model training procedure 120, subsequent to the before-training shuffling, e.g., as described below.

In some demonstrative aspects, the one or more processors 112 may be configured to perform the before-training shuffling on an entire dataset of the plurality of input examples 174 to be used for the ML model training procedure 130, e.g., as described below. In other aspects, the before-training shuffling may be performed only on part of the dataset of the plurality of input examples 174 to be used for the ML model training procedure 130.

In some demonstrative aspects, a count of first-shuffled examples 123 in a shuffled block of the plurality of shuffled blocks may be equal to a count of input examples 121 in an input block of the plurality of input blocks, e.g., as described below. In other aspects, any other count of first-shuffled examples 123 per shuffled block may be implemented.

In some demonstrative aspects, the first data shuffler 120 may be configured to shuffle the plurality of input examples 121 in the plurality of input blocks, for example, by shuffling input examples 121 in a plurality of input block groups, e.g., as described below.

In some demonstrative aspects, a count of input blocks in an input block group of the plurality of input block groups may be equal to a count of shuffled blocks in the group of shuffled blocks utilized by the ML model training procedure 130, e.g., as described below. In other aspects, any other count of input blocks per input block group may be implemented.

In some demonstrative aspects, the first data shuffler 120 may be configured to shuffle the plurality of input examples 121 in the plurality of input blocks, for example, according to a plurality of shuffling iterations, which may be applied to a plurality of input block groups, e.g., as described below.

In some demonstrative aspects, a shuffling iteration of the plurality of shuffling iterations may include determining an input block group for the shuffling iteration, for example, by randomly selecting a group of input blocks from the plurality of input blocks, e.g., as described below.

In some demonstrative aspects, the shuffling iteration of the plurality of shuffling iterations may include randomly assigning input examples from the input block group as first-shuffled examples 123 in a group of shuffled blocks, e.g., as described below.

In some demonstrative aspects, the first data shuffler 120 may be configured to randomly assign input examples 121 from the input block group in a plurality of assignment iterations, e.g., as described below.

In some demonstrative aspects, an assignment iteration may include randomly selecting a plurality of input examples 121 from the input block group, and assigning the plurality of input examples 121 to a shuffled block, e.g., as described below.

In some demonstrative aspects, the first data shuffler 120 may be configured to randomly select the plurality of input examples 121 from the input block group, for example, according to an Independent and Identically Distributed (IID) sampling with replacement, e.g., as described below. In other aspects, any other sampling scheme may be implemented.

In some demonstrative aspects, a count of input blocks in the group of input blocks may be equal to a count of shuffled blocks in the group of shuffled blocks, e.g., as described below. In other aspects, any other count of input blocks per group of input blocks may be implemented.

In some demonstrative aspects, a count of the shuffling iterations may be based on a count of input blocks in the plurality of input blocks, and a count of input blocks in the group of input blocks, e.g., as described below. In other aspects, any other count of shuffling iterations may be implemented.

In some demonstrative aspects, the first data shuffler 120 may be configured to randomly select the group of input blocks according to an IID sampling with replacement. In other aspects, any other selection scheme may be implemented.

In some demonstrative aspects, the second data shuffler 132 may be configured to randomly select the group of shuffled blocks from the plurality of shuffled blocks, for example, according to an IID sampling without replacement. In other aspects, any other sampling scheme may be implemented.

In some demonstrative aspects, the ML model training procedure 130 may include an SGD-based training procedure, e.g., as described below. In other aspects, the ML model training procedure 130 may include any other additional or alternative model training procedure.

In some demonstrative aspects, an update iteration of the plurality of update iterations of the ML model training procedure 130 may include updating the ML model, for example, based on a gradient of an optimization function applied to a second-shuffled example 125 of the plurality of second-shuffled examples 125, e.g., as described below.

In some demonstrative aspects, ML model training procedure 130 may be configured to determine an objective function, denoted F(x), for example, to minimize an average of functions, {ƒ₁, . . . , ƒₘ}, e.g., as follows:

$${min}_{x} F ( x ) = \frac{1}{m} {\sum }_{i = 1}^{m} {f}_{i} ( x )$$

wherein m denotes a count of input examples 121 in the dataset to be used for training the ML model, wherein ƒi denotes a loss over an i-th input example 121, and wherein x denotes a parameter vector including plurality of parameters to be trained for the ML model.

For example, objective function F(x) may represent an average loss over the individual input examples 121, for example, across the entire dataset.

For example, ML model training procedure 130 may be configured to determine a setting of the parameters x, e.g., an optimized setting, which minimizes the objective function F(x).

In some demonstrative aspects, ML model training procedure 130 may be configured to optimize the objective function F(x), for example, according to an SGD-based training procedure, e.g., as described below. In other aspects, ay other suitable procedure may be used.

For example, execution of the SGD-based procedure may include initializing the parameter vector to an initial parameter vector, denoted x₀, and performing a plurality of epochs, e.g., including τ epochs.

For example, an epoch, e.g., each of the epochs, may include multiple iterations of the following procedure:
(1) Sample an example ƒᵢ from the dataset, where i is selected uniformly at random; and
(2) Compute the gradient ∇ƒᵢ(xⱼ₋₁) and update the parameter vector, e.g., as follows:

$${x}_{j} = {x}_{j - 1} - {η}_{j} ∇ {f}_{i} ( {x}_{j - 1} )$$

For example, execution of the SGD-based procedure may be terminated, for example, upon reaching a predetermined number of epochs.

For example, the SGD-based procedure may be implemented to provide a technical solution to guarantee fast convergence, for example, under some assumptions, e.g., when the ƒᵢ-s are convex functions. However, in order to provide good performance, the SGD-based procedure may require random access to individual examples. This requirement may result in inefficient implementation, for example, when training on large datasets, which are remotely stored, e.g., in the cloud.

In some demonstrative aspects, ML model training procedure 130 may be configured to implement a partial online shuffling algorithm, e.g., the CorgiPile algorithm or any other suitable algorithm, which may be implemented as an alternative to SGD with random access, for example, to improve efficiency, e.g., by accessing blocks of examples together.

In some demonstrative aspects, the partial online shuffling algorithm, e.g., the CorgiPile algorithm or any other suitable algorithm, may be configured to operate on the data, which is horizontally, e.g., row-wise, sharded across N blocks of size b, resulting in a dataset size of m=Nb.

In some demonstrative aspects, the partial online shuffling algorithm, e.g., the CorgiPile algorithm or any other suitable algorithm, may include iteratively picking n blocks randomly from the dataset, for example, to fill a buffer of size S; shuffling the buffer; and running an SGD-based procedure on the examples in the buffer.

In some demonstrative aspects, ML model training system 110 may be configured to implement the Corgi² technique, for example, to provide a technical solution to support improved convergence guarantees, e.g., compared to the CorgiPile algorithm, for example, while maintaining efficient data access, e.g., as described below.

In some demonstrative aspects, ML model training system 110 may be configured to implement the Corgi² technique, for example, to provide a technical solution to implement an efficient offline shuffling stage, e.g., by first shuffler 120. For example, the offline shuffling stage may be configured to reorganize the data, e.g., before the training starts.

In some demonstrative aspects, the first shuffler 120 may be configured to utilize a buffer, e.g., a read-write buffer, with a size based on the size of the buffer to be utilized by the ML model training procedure 130.

For example, the first shuffler 120 may be configured to utilize a buffer, e.g., a read-write buffer, with a size S, with random access.

For example, the first shuffler 120 may be configured to utilize a buffer, e.g., a read-write buffer, capable of containing up to nb examples simultaneously, e.g., |S|=nb.

In some demonstrative aspects, the first shuffler 120 may be configured to execute a first shuffling, e.g., an offline shuffling, which may be configured to provide a preprocessed data set, e.g., including the first-shuffled examples 123, for example, by redistributing the input examples 121 among blocks, for example, in a manner that minimizes block variance e.g., as described below.

In some demonstrative aspects, the second shuffler 132 may be configured to provide the plurality of second-shuffled examples 125, for example, by iteratively picking n blocks randomly from the first-shuffled examples 123, for example, to fill the buffer of size S; and shuffling the buffer S.

In some demonstrative aspects, the model update procedure 134 may be configured to apply an SGD-based procedure on the plurality of second-shuffled examples 125 in the buffer S.

In some demonstrative aspects, ML model training system 110 may be configured to implement the Corgi² technique, for example, by performing one or more operations of the following algorithm (Corgi² Algorithm):

The Corgi² Algorithm

1: Input: blocks {Bᵢ}ᵢ₌₁^{N}, each of size b, with a total of Nb examples; a model
parameterized by x; the number of epochs [symbol] ≥ 1; and a buffer size n ≥ 1.

| | |
|---|---|
| 2: | Execute the OfflineCorgiShuffle procedure to obtain the shuffled |
| | Blocks {\tilde{B}_{l,j}}. |
| 3: | Apply the CorgiPile method to the shuffled data {\tilde{B}_{l,j}}. |

4: Output: The updated model parameters [symbol] after [symbol] epochs.

In some demonstrative aspects, the first shuffler 120 may be configured to implement the OfflineCorgiShuffle procedure, for example, by performing one or more operations of the following algorithm (OfflineCorgiShuffle Algorithm):

The OfflineCorgiShuffle Algorithm

| | |
|---|---|
| 1: | Input: blocks {Bᵢ}ᵢ₌₁^{N}, each of size b, with a total of Nb examples; |
| | and a buffer size n ≥ 1. |
| 2: | for l = 1, . . . , N/n do: |
| 3: | Randomly pick n blocks (i.i.d with replacement), and fill the |
| | buffer S. |
| 4: | for j = 1, ... , n do: |
| 5: | Randomly pick b examples from the nb examples in S (i.i.d |
| | with replacement). |
| 6: | Create a new block {\tilde{B}_{l,j}} with the chosen tuples. |
| 7: | end for |
| 8: | end for |
| 9: | $return : \{ {\tilde{B}}_{l , j} \} for j ϵ \{ 1 , … , n \} and l ϵ \{ 1 , … , \frac{N}{n} \} .$ |

In some demonstrative aspects, the ML model training procedure 130 may be configured to implement the CorgiPile method, for example, by performing one or more operations of the following algorithm (CorgiPile Algorithm):

The CorgiPile Algorithm

```
  1: Input: blocks {Bᵢ}ᵢ₌₁^{N}, each of size b, with a total of Nb examples; a model
parameterized by x; the number of epochs [symbol]   ≥ 1; and a buffer size n ≥ 1.
  2: for t = 1, ..., [symbol]   do:
```

| | |
|---|---|
| 3: | Randomly pick n blocks (i.i.d without replacement). |
| 4: | Shuffle the indices of the resulting buffer, obtaining permutation Ψₜ |
| | over {1, ... , nb}. |
| 5: | x₀^{(t)} ← x_{nb}^{(t-1)} |
| 6: | for j = 1, ..., nb do: |
| 7: | xⱼ^{(t)} = xⱼ₋₁^{(t)} − ηₜ∇f_{Ψ}_{ₜ}₍ⱼ₎(xⱼ₋₁^{(t)}). |
| 8: | end for |

9: end for
10: return:

[symbol]

In some demonstrative aspects, it is noted that implementation of the above Corgi² Algorithm may have an additional cost, e.g., in terms of time and/or number of data access queries, which may be relatively low, e.g., minimal, for example, compared to the CorgiPile algorithm.

In some demonstrative aspects, a naive implementation of the above Corgi² Algorithm may substantially double the cost of storage, which may be of some importance in some implementations, e.g., for large datasets.

In some demonstrative aspects, the OfflineCorgiShuffle Algorithm of the above Corgi² Algorithm may be modified, for example, to select the blocks i.i.d. without replacement. According to these aspects, a variant of the above Corgi² Algorithm may be derived, for example, to reorganize the data in-place, and thus consume substantially no extra storage. While this variant may possibly be harder to analyze theoretically, this variant may obtain similar, or even better, performance in practice.

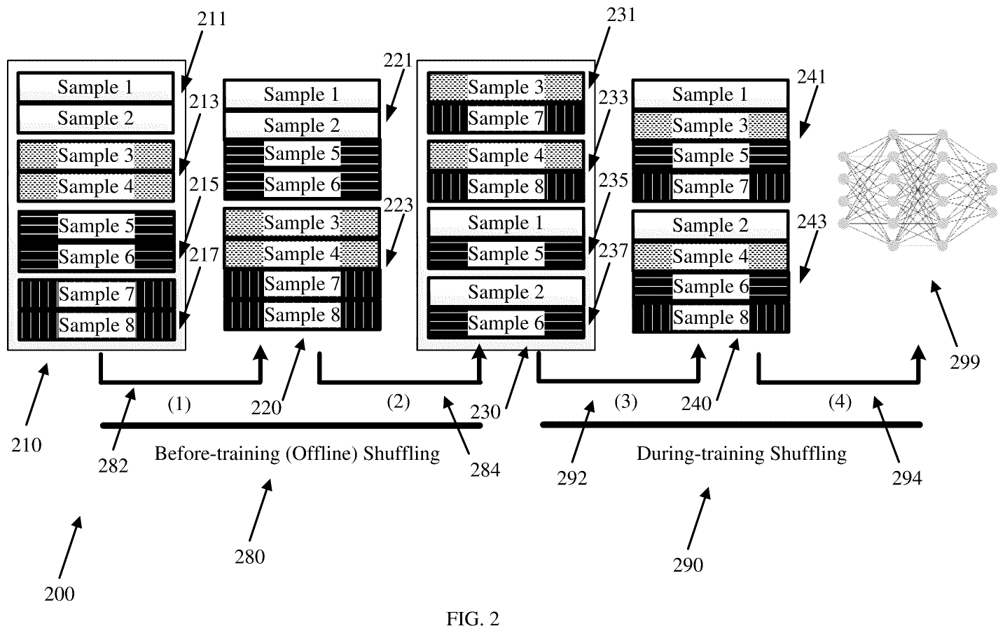

Reference is made to FIG. 2, which schematically illustrates operations according to a Machine Learning (ML) model training technique 200, in accordance with some demonstrative aspects.

For example, ML model training system 110 (FIG. 1) may be configured to perform one or more, e.g., some or all, of the operations of the ML model training technique 200.

In some demonstrative aspects, as shown in FIG. 2, ML model training technique 200 may include a first shuffling 280, e.g., a before training (offline) shuffling, which may be applied to shuffle a plurality of input examples (samples) 210 in a plurality of input blocks, e.g., including an input block 211, an input block 213, an input block 215, and an input block 217.

For example, first shuffler 120 (FIG. 1) may be configured to perform the first shuffling 280.

For example, as shown in FIG. 2, an input block, e.g., each input block, may include two input examples 210.

For example, as shown in FIG. 2, input block 211 may include a first example (Sample 1), and a second example (Sample 2), e.g., which may initially belong to a same storage block.

For example, as shown in FIG. 2, input block 213 may include a third example (Sample 3), and a fourth example (Sample 4), e.g., which may initially belong to a same storage block.

For example, as shown in FIG. 2, input block 215 may include a fifth example (Sample 5), and a sixth example (Sample 6), e.g., which may initially belong to a same storage block.

For example, as shown in FIG. 2, input block 217 may include a seventh example (Sample 7), and an eighth example (Sample 8), e.g., which may initially belong to a same storage block.

In some demonstrative aspects, as shown in FIG. 2, the first shuffling 280 may be configured to shuffle the plurality of input examples 210 in the plurality of input blocks, for example, to provide a plurality of first-shuffled examples 230 in a plurality of shuffled blocks, e.g., including a shuffled block 231, a shuffled block 233, a shuffled block 235, and a shuffled block 237.

For example, as shown in FIG. 2, a shuffled block, e.g., each shuffled block, may include two first-shuffled examples 230.

For example, as shown in FIG. 2, shuffled block 231 may include the Sample 3, e.g., from the input block 213, and the Sample 7, e.g., from the input block 217.

For example, as shown in FIG. 2, shuffled block 233 may include the Sample 4, e.g., from the input block 213, and the Sample 8, e.g., from the input block 217.

For example, as shown in FIG. 2, shuffled block 235 may include the Sample 1, e.g., from the input block 211, and the Sample 5, e.g., from the input block 215.

For example, as shown in FIG. 2, shuffled block 237 may include the Sample 2, e.g., from the input block 211, and the Sample 6, e.g., from the input block 215.

In some demonstrative aspects, as shown in FIG. 2, the first shuffling 280 may include shuffling the plurality of input examples 210 in the plurality of input blocks, for example, by shuffling input examples in a plurality of input block groups 220.

For example, the first shuffling 280 may include randomly selecting groups (sets) 220 of input blocks from the dataset, and string the input block groups 220, e.g., in a local buffer.

For example, as shown in FIG. 2, the plurality of input block groups 220 may include a first input block group 221 and a second input block group 223.

In some demonstrative aspects, as shown in FIG. 2, the first shuffling 280 may include shuffling the plurality of input examples 210 in the plurality of input blocks, for example, according to a plurality of shuffling iterations applied to the plurality of input block groups 220, e.g., as described below.

For example, the local buffer may be randomly shuffled and written into new (shuffled) blocks.

In some demonstrative aspects, a shuffling iteration of the plurality of shuffling iterations may include determining an input block group for the shuffling iteration by randomly selecting a group of input blocks from the plurality of input blocks.

In some demonstrative aspects, the group of input blocks may be randomly selected, for example, according to an IID sampling with replacement, e.g., as described above.

In some demonstrative aspects, the shuffling iteration may include randomly assigning input examples from the input block group as first-shuffled examples in a group of shuffled blocks.

For example, as shown in FIG. 2, a first shuffling iteration may include determining the input block group 221 for the first shuffling iteration, for example, by randomly selecting a first group of input blocks, e.g., including the input blocks 211 and 215, from the plurality of input blocks.

For example, as shown in FIG. 2, the first shuffling iteration may include randomly assigning input examples from the first input block group 221 as first-shuffled examples in a first group of shuffled blocks, e.g., including the shuffled block 235 and the shuffled block 237.

For example, as shown in FIG. 2, a second shuffling iteration may include determining the input block group 223 for the second shuffling iteration, for example, by randomly selecting a second group of input blocks, e.g., including the input blocks 213 and 217, from the plurality of input blocks.

For example, as shown in FIG. 2, the second shuffling iteration may include randomly assigning input examples from the second input block group 223 as first-shuffled examples in a second group of shuffled blocks, e.g., including the shuffled block 231 and the shuffled block 233.

In some demonstrative aspects, the shuffling iteration may include randomly assigning input examples from the input block group for the shuffling iteration in a plurality of assignment iterations.

In some demonstrative aspects, an assignment iteration may include randomly selecting a plurality of input examples from the input block group and assigning the plurality of input examples to a shuffled block.

In some demonstrative aspects, the plurality of input examples may be randomly selected from the input block group, for example, according to an IID sampling with replacement, e.g., as described above.

For example, the first shuffling iteration may include randomly assigning input examples from the input block group 221 in a plurality of assignment iterations.

For example, a first assignment iteration of the first shuffling iteration may include randomly selecting a first plurality of input examples from the input block group 221, e.g., the Sample 1 and the Sample 5, and assigning the first plurality of input examples to the shuffled block 235.

For example, a second assignment iteration of the first shuffling iteration may include randomly selecting a second plurality of input examples from the input block group 221, e.g., the Sample 2 and the Sample 6, and assigning the second plurality of input examples to the shuffled block 237.

For example, the second shuffling iteration may include randomly assigning input examples from the input block group 223 in a plurality of assignment iterations.

For example, a first assignment iteration of the second shuffling iteration may include randomly selecting a first plurality of input examples from the input block group 223, e.g., the Sample 3 and the Sample 7, and assigning the first plurality of input examples to the shuffled block 231.

For example, a second assignment iteration of the second shuffling iteration may include randomly selecting a second plurality of input examples from the input block group 223, e.g., the Sample 4 and the Sample 8, and assigning the second plurality of input examples to the shuffled block 233.

In some demonstrative aspects, a shown inf FIG. 2, ML model training technique 200 may include providing the plurality of first-shuffled examples 230 in the plurality of shuffled blocks as an input to a model training procedure, which may include a second shuffling 290, e.g., a during-training (online) shuffling, e.g., as described below.

For example, as shown in FIG. 2, groups (sets) of the shuffled blocks may be loaded, e.g., at random, to the local buffer, for example, during the ML model training, e.g., as described below.

For example, during the ML model training each group (set) of the shuffled blocks in the buffer may be shuffled and processed with the SGD procedure, e.g., as described below.

In some demonstrative aspects, the model training procedure may include a plurality of epoch iterations applied to a plurality of block groups, e.g., as described above.

In some demonstrative aspects, an epoch iteration of the plurality of epoch iterations may include determining a block group for the epoch iteration, for example, by randomly selecting a group of shuffled blocks from the plurality of shuffled blocks, e.g., as described above.

In some demonstrative aspects, the epoch iteration may include shuffling first-shuffled examples in the block group to provide a plurality of second-shuffled examples, e.g., as described above.

In some demonstrative aspects, the epoch iteration may include updating the ML model according to a plurality of update iterations applied to the plurality of second-shuffled examples, e.g., as described above.

For example, as shown in FIG. 2, a during-training shuffling in a first epoch iteration may include determining a block group 241 for the first epoch iteration, for example, by randomly selecting a group of shuffled blocks, e.g., including the shuffled block 231 and the shuffled block 235, from the plurality of shuffled blocks.

For example, as shown in FIG. 2, the during-training shuffling in the first epoch iteration may include shuffling first-shuffled examples in the block group 241 to provide a first plurality of second-shuffled examples for the first epoch iteration, e.g., including the Sample 1, the Sample 3, the Sample 5, and the Sample 7.

For example, as shown in FIG. 2, the first epoch iteration may include updating the ML model (294) according to a plurality of update iterations (299) applied to the first plurality of second-shuffled examples in the block group 241.

For example, as shown in FIG. 2, a during-training shuffling in a second epoch iteration may include determining a block group 243 for the second epoch iteration, for example, by randomly selecting a group of shuffled blocks, e.g., including the shuffled block 233 and the shuffled block 237, from the plurality of shuffled blocks.

For example, as shown in FIG. 2, the during-training shuffling in the second epoch iteration may include shuffling first-shuffled examples in the block group 243 to provide a second plurality of second-shuffled examples for the second epoch iteration, e.g., including the Sample 2, the Sample 4, the Sample 6, and the Sample 8.

For example, as shown in FIG. 2, the first epoch iteration may include updating the ML model (294) according to a plurality of update iterations (299) applied to the second plurality of second-shuffled examples in the block group 243.

In some demonstrative aspects, as shown in FIG. 2, a count of input blocks in an input block group of the plurality of input block groups may be equal to a count of shuffled blocks in a group of shuffled blocks.

For example, as shown in FIG. 2, each of input block groups 221 and 223 may include two input blocks, and each of the block group 241 and the block group 243 may include examples from two shuffled blocks.

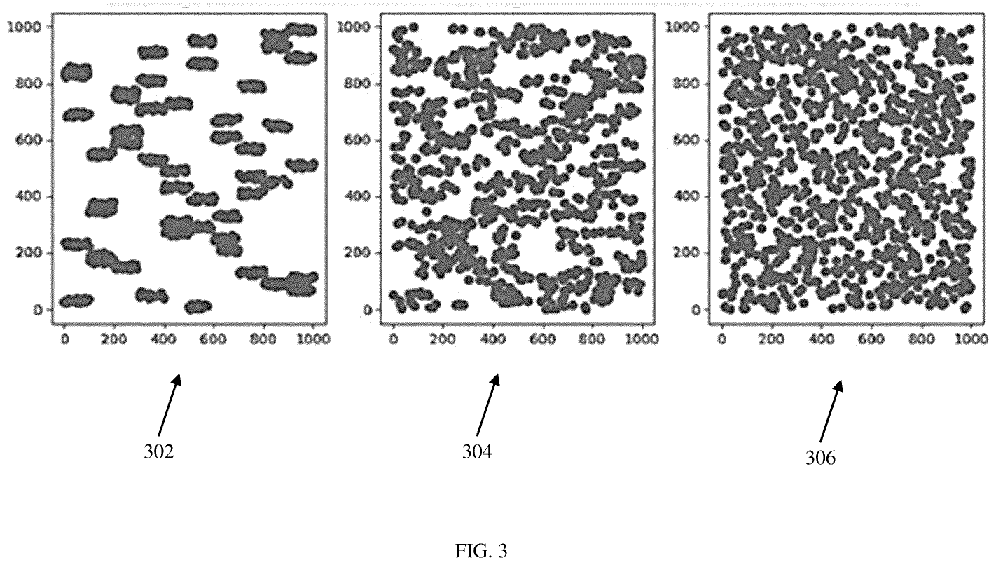

Reference is made to FIG. 3, which illustrates a graph 304 depicting simulation results of a data distribution according to a dual-shuffling technique, compared to a graph 302 depicting simulation results of a data distribution according to a single-shuffling technique, and a graph 306 depicting simulation results of a data distribution full-shuffling technique, in accordance with some demonstrative aspects.

For example, the simulation results of graphs 304, 306, and 308 represent simulated results with respect to shuffling of a data set {1, . . . , 1000} including 1000 examples (samples).

For example, the simulation results of graph 304 may relate to a dual-shuffling technique, which may be implemented, for example, by the ML model training system 110 (FIG. 1), e.g., as described above.

For example, the simulation results of graph 302 may relate to a partial-online shuffling technique, for example, according to the CorgiPile algorithm, e.g., as described above.

For example, the simulation results of graph 306 may relate to a full-shuffling technique, e.g., as described above.

For example, as shown in FIG. 3, the dual-shuffling technique may be implemented to provide a technical solution to support shuffling, which is relatively close to a uniform shuffling, as may be seen from a comparison between the graph 304 and the graph 306.

For example, as shown in FIG. 3, the dual-shuffling technique (graph 304) may be implemented to provide a technical solution to support spreading of the data samples more uniformly across the shuffled buffer, e.g., compared to the shuffling provided by the partial-online shuffling technique (graph 302).

Referring back to FIG. 1, in some demonstrative aspects, the ML model training system 110 may be configured to implement operations of the dual-shuffling technique, which may be configured to provide a technical solution to support improved performance and/or efficiency of the ML model training procedure, e.g., as described below.

In some demonstrative aspects, the convergence time of the Corgi² technique, e.g., as described above, may be analyzed, under some assumptions, e.g., as described below.

In some demonstrative aspects, it may be shown that the cost of the additional first shuffling (offline) stage, e.g., in terms of data access, may be relatively small, e.g., as described below.

In some demonstrative aspects, the Corgi² technique may be implemented to achieve faster convergence, e.g., compared to the CorgiPile algorithm, for example, by reducing the variance between blocks in the offline stage, e.g., as described below.

For example, the variance between the blocks may be represented, e.g., as follows:

$$\frac{1}{N} {\sum }_{l = 1}^{N} {‖ ∇ {f}_{{B}_{l}} ( x ) - ∇ F ( x ) ‖}^{2} \leq {h}_{D} \frac{{σ}^{2}}{b} \qquad ( 1 )$$

For example, the variance may be between the average gradient induced by functions in the different blocks, wherein

$$∇ {f}_{{B}_{l}} := \frac{1}{b} {\sum }_{i ∈ {B}_{l}} ∇ {f}_{i}$$

is the mean gradient in the l-th block, and h_{D} represents a constant that characterizes the variability of this block-wise gradient. For example, the constant h_{D} may be a characteristic of the dataset, and may range from h_{D}=1, e.g., in a perfectly heterogeneous dataset where each block has the same distribution as all the others, to h_{D}=b, e.g., in a highly homogeneous dataset where the blocks are very different from one another. For example, in case of an image dataset in which each block includes sequential frames from a single video, images in the same video may usually be highly correlated with each other, and may have low correlation with images in a different video.

In some demonstrative aspects, it may be shown that after the first shuffling (offline) stage of the Corgi² technique, e.g., after running the OfflineCorgiShuffle algorithm, the block-wise variance may decrease, e.g., compared to the variance of the original blocks, e.g., as described below.

For example, a first Theorem (Theorem 1) may be defined, for example, considering execution of the OfflineCorgiShuffle algorithm on a dataset characterized by a variance bound σ², a block-wise gradient variance parameter h_{D}, N blocks, e.g., each containing b examples, and a buffer size nb.

For example, according to the Theorem 1, the following inequality holds for all x:

$$𝔼 [ \frac{1}{N} {\sum }_{l = 1}^{N} {‖ ∇ {f}_{{\tilde{B}}_{l}} ( x ) - ∇ F ( x ) ‖}^{2} ] \leq {h}_{D}^{′} \frac{{σ}^{2}}{b} \qquad ( 2 )$$

wherein:

$${h}_{D}^{′} = 1 + ( \frac{1}{n} + \frac{1}{n b} ) {h}_{D}$$

wherein ƒ_{\tilde{B}}_{ₗ}(x) denotes the average of examples in \tilde{B}ₗ, which denotes the l-th block generated by the OfflineCorgiShuffle algorithm.

For example, for values of b, which are not trivially small,

$${h}_{D}^{′} \approx \frac{1}{n} {h}_{D} .$$

For example, it may follow from the above that increasing the buffer size (and thus n, the number of blocks that can fit in the buffer at once) linearly reduces variance.

For example, it may follow from the above that the larger the original h_{D} is, the more variance will be reduced by the Corgi² algorithm, e.g., in absolute terms. This corresponds to the intuition that the Corgi² algorithm may help the most in datasets with very homogeneous blocks.

For example, this reduction in block-wise variance significantly reduces the anticipated disparity in distribution between each of the buffers created during a CorgiPile execution, and the overall distribution of the dataset. In turn, this lowers the convergence rate, bringing it closer to that of random access SGD during training. Further elaboration on this relationship is provided in a second Theorem (Theorem 2), e.g., as described below.

A proof sketch of the Theorem 1 is provided below.

For example, since the OfflineCorgiShuffle algorithm works on each generated block \tilde{B}ₗ independently, we analyze a single iteration of the algorithm. We focus on the expression:

$${V}_{S , {\tilde{B}}_{l}} ( ∇ {f}_{{\tilde{B}}_{l}} ) := \frac{1}{N} {\sum }_{l = 1}^{N} {‖ ∇ {f}_{{\tilde{B}}_{l}} ( x ) - ∇ F ( x ) ‖}^{2}$$

wherein S denotes a vector representation of the buffer, \tilde{B}ₗ represents the block created from S by uniformly sampling from the buffer, and l denotes a uniformly sampled index. This is a measure of variance that generalizes scalar variance, expressed as a scalar rather than a matrix. This measure, has similar properties to standard variance, such as V(αX)=α² V(X) and law of total variance, e.g., as described below.

Thus we can decompose the left hand side of the theorem equation using the law of total variance:

$$\frac{1}{N} {\sum }_{l = 1}^{N} {‖ ∇ {f}_{{\tilde{B}}_{l}} ( x ) - ∇ F ( x ) ‖}^{2} = {V}_{S , {\tilde{B}}_{l}} ( ∇ {f}_{{\tilde{B}}_{l}} ( x ) ) == {\underbrace{{V}_{S} ( {𝔼}_{{\tilde{B}}_{l}} [ ∇ {f}_{{\tilde{B}}_{l}} \vert S ] )}}_{( i )} + {\underbrace{{𝔼}_{S} [ {V}_{{\tilde{B}}_{l}} ( ∇ {f}_{{\tilde{B}}_{l}} \vert S ) ]}}_{( ii )}$$

For example, when S is fixed, for any l in range, \tilde{B}ₗ is an unbiased i.i.d selection of b examples from it.

For example, in (i), given fixed S we have

$${𝔼}_{{\tilde{B}}_{l}} ∇ {f}_{{\tilde{B}}_{l}} \vert S = ∇ {f}_{S} := \frac{1}{n b} {\sum }_{i ∈ S} ∇ {f}_{i} ,$$

i.e., the average gradient in the buffer.

In turn, since S is an i.i.d sampling of n blocks, the variance of its average is equal to 1/n of the variance of sampling the average of a single block, which gives us:

$$( i ) : {V}_{S} ( {𝔼}_{{\tilde{B}}_{l}} [ ∇ {f}_{{\overline{B}}_{l}} \vert S ] ) = {V}_{S} ( ∇ {f}_{S} \vert S ) = \frac{1}{n} {V}_{i} ( ∇ {f}_{{B}_{i}} ) \leq \frac{1}{n} {h}_{D} \frac{{σ}^{2}}{b}$$

wherein Bᵢ is the i^{th} block, before applying the OfflineCorgiShuffle algorithm.

For example, for term (ii), we apply Bienaymé's identity and use the fact that averaging b i.i.d. elements decreases the variance by a factor of 1/b compared to the variance of sampling a single element.

Given that, and letting i be an index selected uniformly from 1, . . . , bn, we observe that

$${𝔼}_{S} [ {V}_{{\tilde{B}}_{l}} ( ∇ {f}_{{\tilde{B}}_{l}} \vert S ) ] = \frac{1}{b} {𝔼}_{S} [ {V}_{i} ( {S}_{i} \vert S ) ] .$$

This expression can be decomposed to:

$${𝔼}_{S} [ {V}_{{\tilde{B}}_{l}} ( ∇ {f}_{{\tilde{B}}_{l}} \vert S ) ] = \frac{1}{b} {𝔼}_{S} [ {V}_{i} ( {S}_{i} \vert S ) ] = \frac{1}{b} ( {\underbrace{{V}_{i} ( {S}_{i} )}}_{I} - {\underbrace{{V}_{S} ( {E}_{i} [ {S}_{i} \vert S ] )}}_{II} ) .$$

For example, the component (I) is the variance of sampling one element from the buffer, before the buffer itself is known. Since every example from the dataset has the same probability of being the i^{th} example in S, this variance is equal to the variance of the dataset itself, which is bounded by σ².

Moreover, the component (II) is the variance of the average of S, and exactly like in (i), it equals the pre-shuffle blockwise variance. Put together, this may result in:

$$( ii ) : {𝔼}_{S} [ {V}_{{\tilde{B}}_{l}} ( ∇ {f}_{{\tilde{B}}_{l}} \vert S ) ] = \frac{1}{b} {𝔼}_{S} [ {V}_{i} ( {S}_{i} \vert S ) ] \leq ( 1 + \frac{1}{n b} {h}_{D} ) \frac{{σ}^{2}}{b}$$

Combining the bounds for (i) and (ii) yield the result. A full detailed proof for Theorem 1 is provided below.

A convergence rate analysis of the Corgi² algorithm is provided below.

For example, the convergence rate of techniques based on partial-shuffling, e.g., the CorgiPile algorithm, is expected to be slower (in terms of epochs) than that of random access SGD, especially when the individual buffers significantly differ from the distribution of the dataset as a whole.

Specifically, larger values of n/N would guarantee faster convergence time as more of the dataset is shuffled together in each iteration; and higher values of h_{D} would hurt convergence time as the variance in each iteration is increased.

For example, in the following theorem we revisit the convergence rate upper bound associated with the CorgiPile algorithm and establish the extent to which the Corgi² algorithm may contributes to its reduction.

For example, a second Theorem (Theorem 2) may be defined, for example, supposing that F(x) are smooth and μ-strongly convex function. Let T= [symbol] nb be the total number of examples seen during training, where [symbol] ≥1 is the number of buffers iterated. Choose the learning rate to be

$${η}_{t} = \frac{6}{bn μ ( t + a )} ,$$

where:

$$a \geq max \{ \frac{8 L G + 24 {L}^{2} + 28 {L}_{H} G}{{μ}^{2}} , \frac{24 L}{μ} \} .$$

Then, the Corgi² algorithm has the following convergence rate in the online stage, e.g., for any choice of x₀:

$$𝔼 [ F ( {\overline{x}}_{𝒯} ) - F ( {x}^{*} ) ] \leq ( 1 - α ) {h}_{D}^{′} {σ}^{2} \frac{1}{T} + β \frac{1}{{T}^{2}} + γ \frac{{( N b )}^{3}}{{T}^{3}} , \qquad ( 3 )$$

where:

$${\overline{X}}_{𝒯} = \frac{{\sum }_{t} {( t + a )}^{3} {x}_{t}}{{\sum }_{t} {( t + a )}^{3}} ,$$

$$and$$

$$α := \frac{n - 1}{N - 1} ,$$

$$β := {α}^{2} + {( 1 - α )}^{2} {( b - 1 )}^{2} ,$$

$$γ := \frac{{n}^{3}}{{N}^{3}} .$$

A full proof for this Theorem 2 is provided below. This proof may be based on wrapping the convergence rate proved for the CorgiPile algorithm in an expectation over the randomness of the OfflineCorgiShuffle algorithm and updating the expression accordingly. The convergence rate for CorgiPile algorithm in the same setting is:

$$𝔼 [ F ( {\overline{x}}_{𝒯} ) - F ( {x}^{*} ) ] \leq ( 1 - α ) {h}_{D} {σ}^{2} \frac{1}{T} + β \frac{1}{{T}^{2}} + γ \frac{{N}^{3} {b}^{3}}{{T}^{3}} , \qquad ( 4 )$$

For example, it may be observed that the difference between these methods is expressed in the replacement of the block-wise variance parameter h_{D} with h′_{D}. As is shown in the Theorem 1, h′_{D} will be lower in practically all cases. Here we see that h′_{D} controls the convergence rate, as it linearly impacts the leading term 1/T.

For example, in view of the above analysis it may be determined when the Corgi² algorithm may be expected to converge significantly faster than the CorgiPile algorithm.

Specifically, when the original blocks are homogeneous, we expect that h_{D}=Θ(b), in which case the Corgi² algorithm will improve the convergence rate, e.g., by a factor of 1/n (where n is the number of blocks in the buffer).

On the other hand, when data is already shuffled, we expect that h_{D}=Θ(1), in which case the Corgi² algorithm may not be expected to provide a significant improvement, and may even possibly hurt convergence in some cases.

For example, it may be shown that the Corgi² algorithm may improve data efficiency by a factor of 1/b over a full shuffle, e.g., as described below.

In some demonstrative aspects, the Corgi² algorithm may be implemented to provide a technical solution to support an improved convergence rate, for example, by improving the convergence rate of the CorgiPile algorithm by a significant factor, e.g., as described above.

In some demonstrative aspects, an analysis may be performed to quantify an expected increase in query complexity, which may be associated with the Corgi² algorithm, e.g., as described below.

For example, the storage system conceptualized as managing chunks including b examples, where each input/output (IO) operation pertains to an entire chunk. Consequently, the cost incurred for accessing a single example or all b examples within the same chunk remains identical. This unpretentious modeling aptly delineates the cost structure associated with cloud-based data storage, given that providers may impose a fixed fee for each object access, irrespective of the object's size. Bearing this model in mind, we can evaluate various shuffling algorithms by employing the elementary metric of number of data access operations.

For example, the number of data access queries of the Corgi² algorithm may be compared to other shuffling approaches, for example, including the CorgiPile algorithm, a random access SGD algorithm, and a one-time shuffling of the data, e.g., as follows:

TABLE 1

| Algorithm | # Offline queries | # Online queries | Total |
|---|---|---|---|
| Random Access | — | [symbol] m | [symbol] m |
| Shuffle-Once | m + m/b | [symbol] m/b | m + ( [symbol] + 1)m/b |
| CorgiPile | — | [symbol] m/b | [symbol] m/b |
| Corgi ² | 2m/b | [symbol] m/b | ( [symbol] + 2)m/b |

For example, as shown in Table (1), the random access SGD algorithm may require [symbol] m queries, where [symbol] denotes the number of training epochs.

For example, as shown in Table (1), the one-time shuffling approach (ShuffleOnce) may require m+( [symbol] +1)m/b queries, e.g., including m read operations for one example each, accompanied by m/b write operations to store the data in shuffled chunks, and then [symbol] m/b read operations to fetch full chunks during training.

For example, as shown in Table (1), the CorgiPile algorithm may have a cost of only [symbol] m/b queries in total, e.g., since each chunk is read exactly once in each epoch.

For example, as shown in Table (1), the Corgi² algorithm may incurs an additional cost of 2m/b queries (read+write) in the preceding offline phase. Thus, up to a small constant factor, the Corgi² algorithm may use substantially the same number of queries as the CorgiPile algorithm.

For example, it is noted that the metric used above expresses query complexity, e.g., rather than time complexity, for example, since realistic executions of shuffle methods may rely heavily on parallelization techniques, which might be limited by factors such as, for example, software implementation and/or the throughput limits of the storage system.

For example, the Corgi² algorithm itself may impose no substantial bottlenecks on parallelization, meaning that it should enjoy similar benefits to run time complexity as those of the other shuffling methods.

Following is a description of experiments performed to examine some of the expected performance enhancements which may be achieved by implementation of the Corgi² algorithm.

For example, it has been posited that the CorgiPile algorithm may be utilized to rival the SGD algorithm, for example, when large buffer sizes are used, e.g., as has been evidenced by empirical evaluations on datasets such as CIFAR-10, Criteo, and yfcc100m.

For example, in recognizing the impracticality of large buffer sizes in many real-world applications, the following analysis focuses on the comparative performance of the Corgi² algorithm vis-à-vis SGD, for example, in the context of feasible buffer sizes, e.g., where the CorgiPile algorithm may be expected to be suboptimal.

For example, as discussed below, a series of experiments have been designed to assess the efficacy of the Corgi² algorithm, e.g., under these constraints. Through this approach, at least some of the conditions under which the Corgi² algorithm outperforms other methods may be defined, thereby providing insights into its potential for integration into machine learning workflows where resource optimization is paramount.

For example, the experiments have been carried out according to an experimental setting corresponding to two types of tasks, e.g., image classification and next-token text prediction. For example, more emphasis may be put on the on the next-token text prediction task, as it is the one where data is most likely to be available in highly homogeneous clusters.

For example, a first image classification task may be based on a ResNet-18 neural network model with a CIFAR-100 dataset, for example, as a baseline “simple” task with relatively little data and few classes.

For example, a second image classification task may be based on a ResNet-50 neural network model with an ImageNet dataset, for example, representing a step up in task complexity, e.g., since there are considerably more classes.

For example, a third image classification task may be based on a proprietary image classification model with an extremely large proprietary dataset. For example, the proprietary dataset may include video clips taken from cars equipped with cameras. For example, such a dataset may represent a clean, real world example use case of a dataset in the size of multiple hundreds of terabytes, e.g., for which a 2% buffer size may be impractical, where the data arrives in a highly clustered format, e.g., since the frames in a single clip are correlated amongst themselves.

For example, the next-token text prediction task may be based on a GPT-2 model with a new dataset (TextTile) dataset, which may include texts from different sources with 10 distinct writing styles, e.g., social media posts, code snippets, poems, courtroom protocols, and the like, which may be organized into files that each contain text from a single style. This task may be used to simulate the behavior of clustering images according to classes in image classification tasks, for the next-word prediction task used here.

For example, in a first experiment, the open-source models were trained with a full shuffle, e.g., to closely simulate SGD, but faster in practice; with the CorgiPile algorithm; and with the Corgi² algorithm, for example, using buffer sizes of 1% and 0.25%.

For example, in a second experiment, training was performed for the same buffer sizes, with different values for n (number of blocks per buffer) and b (number if items per block).

For example, in a third experiment, training was performed for a proprietary image classifier.

For example, the shuffler of the Corgi² algorithm was implemented within a PyTorch framework. For example, indexes of the dataset were allocated to blocks, which were then shuffled, e.g., according to the CorgiPile algorithm, the Corgi² algorithm, or the full shuffle algorithm, e.g., before the training.

For example, for the CIFAR-100 dataset, the ResNet-18 model was trained for 200 epochs with a batch size of 256, a learning rate 0.1, a momentum 0.9, a weight decay 5e-4, and a Cosine Annealing LR scheduler. Standard data augmentations were used, e.g., random crops, horizontal flips, rotations, and normalization, e.g., with the standard mean and std for CIFAR-100.

For example, for the ImageNet dataset, the ResNet-50 model was trained for 100 epochs, with a batch size 2048, a learning rate 0.1, a momentum 0.9, a weight decay 1e-4, and a Cosine Annealing LR scheduler. The PyTorch AutoAugment functionality was used followed by a random horizontal flip and normalization, e.g., with the standard mean and std for ImageNet, for data augmentation.

For example, for the TextTile dataset, the GPT-2 model was trained for 100 epochs, e.g., with each epoch defined as 10000 steps with a batch size of 128, a learning rate 0.001, an AdamW optimizer with weight decay 1e-4, and a Cosine Annealing LR scheduler. The data was tokenized with a GPT2Tokenizer instance from the HuggingFace library.

For example, the parameters n and b were changed, e.g., to fit the target buffer ratio for each experiment, for example, while maintaining the values when comparing between the CorgiPile algorithm and the Corgi² algorithm on the same buffer ratio.

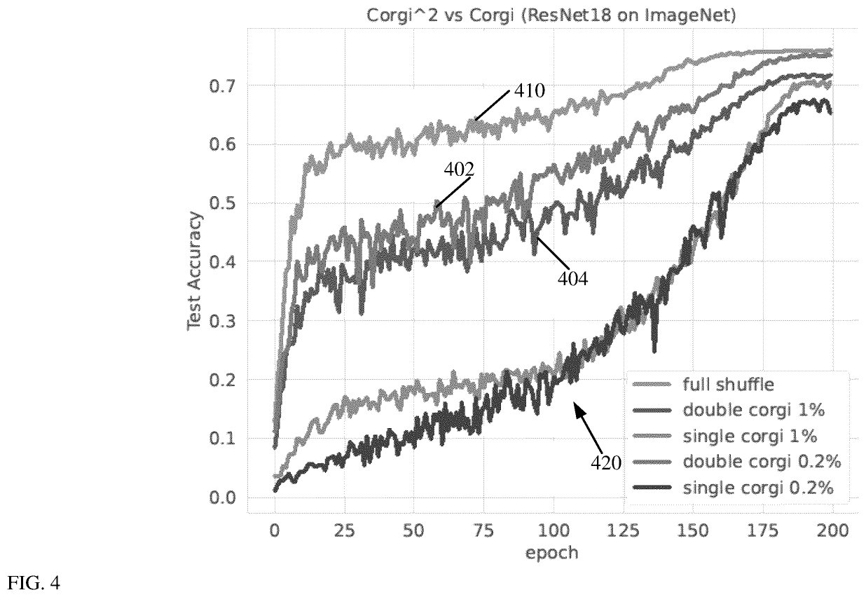

Reference is made to FIGS. 4-11, which illustrate graphs depicting simulation results of the performance of the dual-shuffling technique described above, e.g., the Corgi² algorithm (also referred to as “double Corgi”), compared to performances of a single-shuffling technique, e.g., the CorgiPile algorithm (also referred to as “single Corgi”), and a full-shuffling technique, in accordance with some demonstrative aspects.

For example, FIG. 4 depicts graphs representing the simulation results of the first experiment for the ResNet-18 neural network model with the CIFAR-100 dataset.

For example, a graph 402 represents the simulation results for the Corgi² algorithm with the buffer size of 0.2%, and a graph 404 represents the simulation results for the Corgi² algorithm with the buffer size of 1%.

For example, a graph 410 represents the simulation results for the full shuffle, and graphs 420 represent the simulation results for the CorgiPile algorithm with the buffer sizes of 0.2% and 1%.

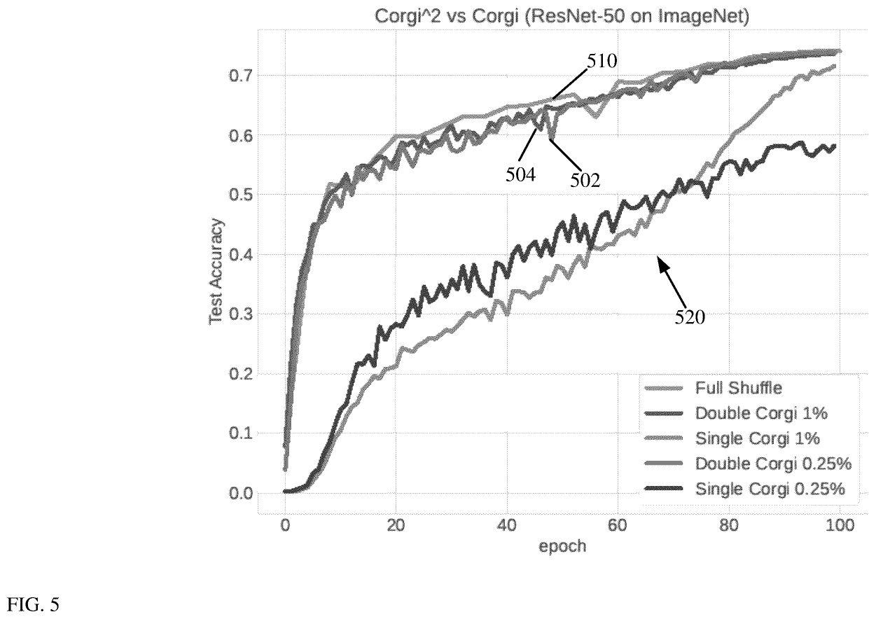

For example, FIG. 5 depicts graphs representing the simulation results of the first experiment for the ResNet-50 neural network model with the ImageNet dataset.

For example, a graph 502 represents the simulation results for the Corgi² algorithm with the buffer size of 0.25%, and a graph 504 represents the simulation results for the Corgi² algorithm with the buffer size of 1%.

For example, a graph 510 represents the simulation results for the full shuffle, and graphs 520 represent the simulation results for the CorgiPile algorithm with the buffer sizes of 0.25% and 1%.

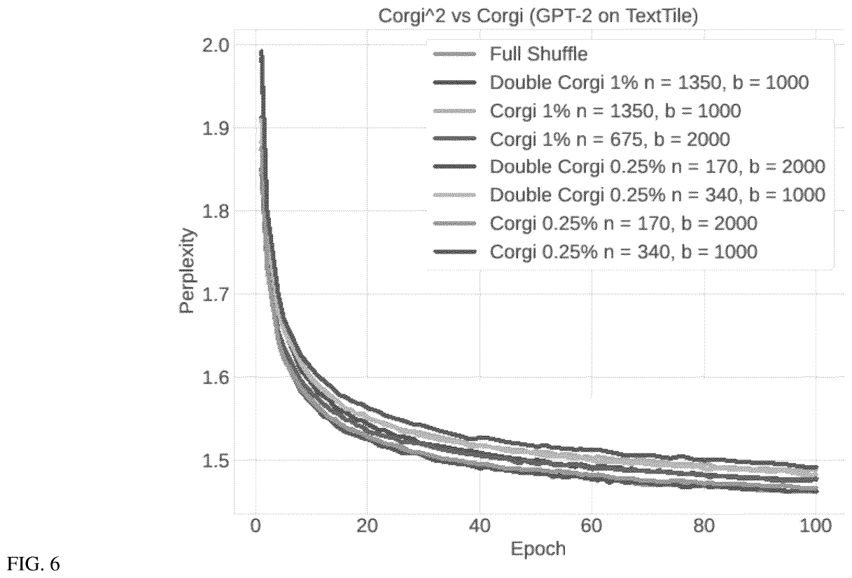

For example, FIG. 6 depicts graphs representing the simulation results of the first experiment for the GPT-2 model with the TextTile dataset with respect to the full shuffle, the Corgi² algorithm, and the CorgiPile algorithm.

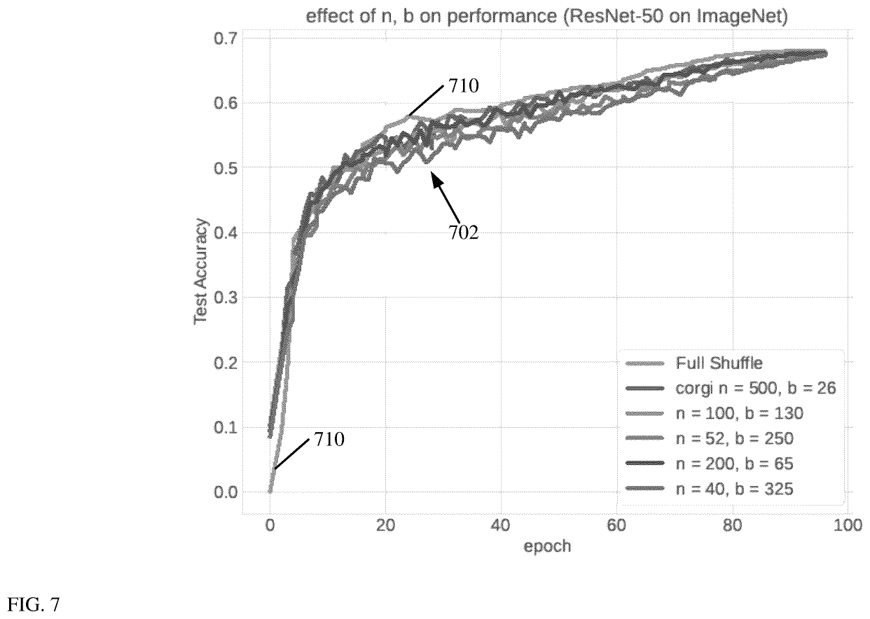

For example, FIG. 7 depicts graphs representing the simulation results of the second experiment for the ResNet-50 neural network model with the ImageNet dataset with the buffer size of 1%.

For example, a graph 710 represents the simulation results for the full shuffle, and graphs 702 represents the simulation results for the Corgi² algorithm with different values for n (number of blocks per buffer) and b (number if items per block).

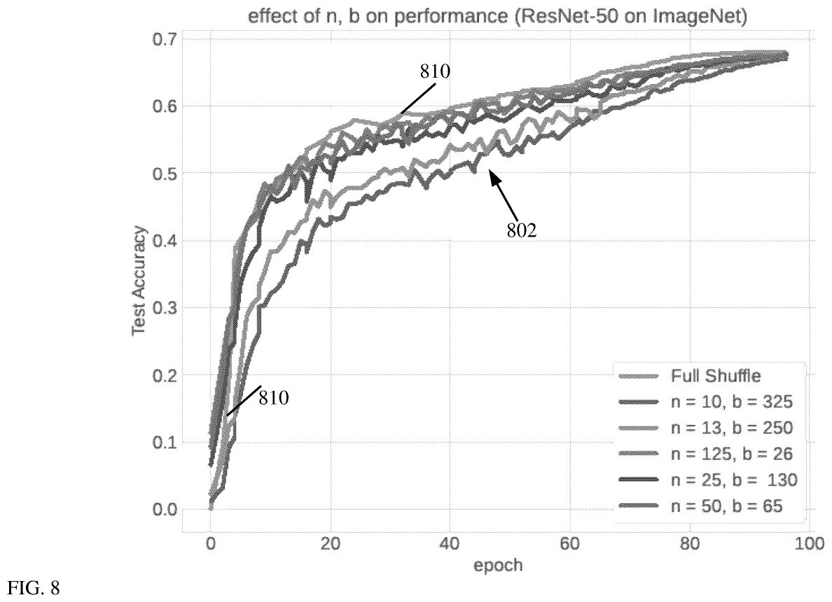

For example, FIG. 8 depicts graphs representing the simulation results of the second experiment for the ResNet-50 neural network model with the ImageNet dataset with the buffer size of 0.25%.

For example, a graph 810 represents the simulation results for the full shuffle, and graphs 802 represents the simulation results for the Corgi² algorithm with different values for n (number of blocks per buffer) and b (number if items per block).

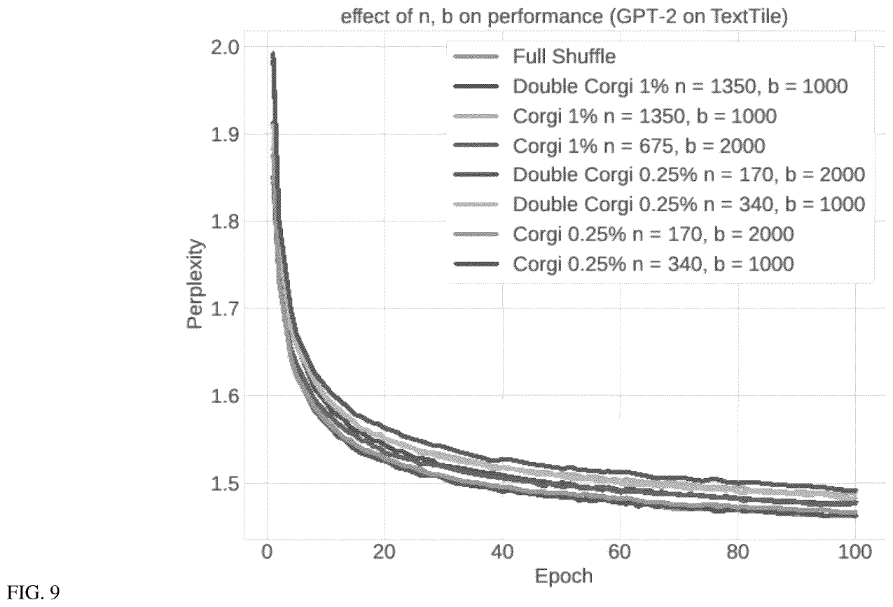

For example, FIG. 9 depicts graphs representing the simulation results of the second experiment for the GPT-2 model with the TextTile dataset with respect to the full shuffle, the Corgi² algorithm, and the CorgiPile algorithm, with buffer sizes of 0.25%, and a 1%, and with different values for n (number of blocks per buffer) and b (number if items per block).

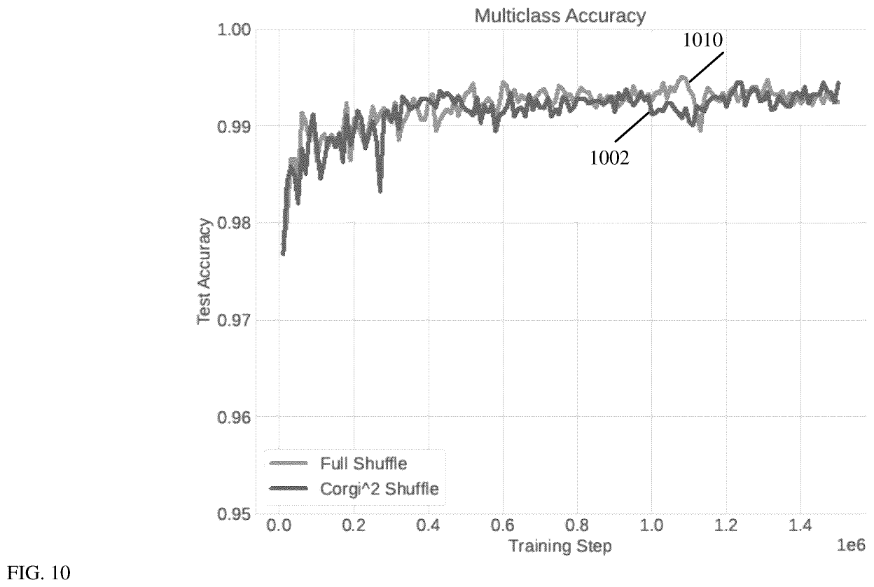

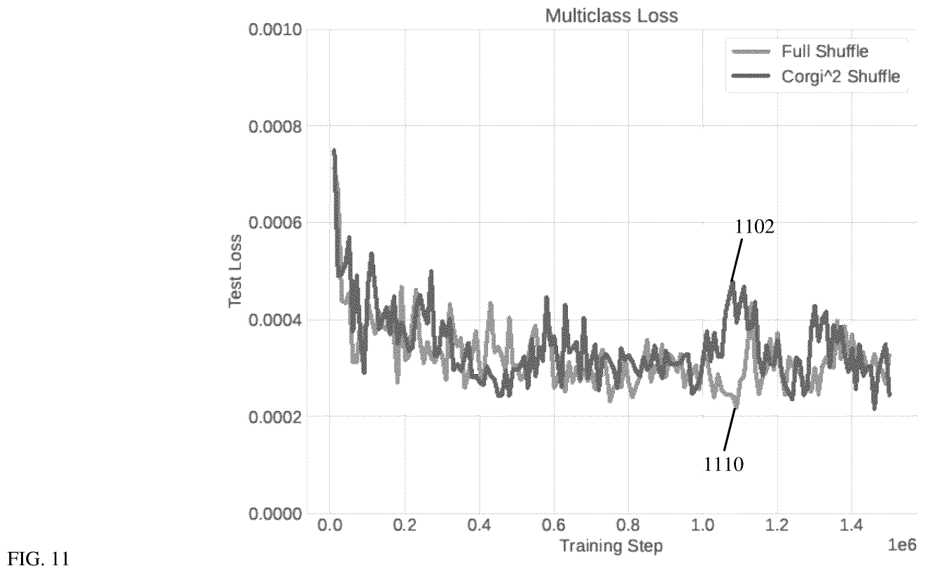

For example, FIGS. 10 and 11 depict graphs representing the simulation results of the third experiment for the proprietary model in the real world setting.

For example, a graph 1002 represents the simulation results for the accuracy level of the Corgi² algorithm, and a graph 1010 represents the simulation results for the accuracy level of SGD with the full shuffle.

For example, a graph 1102 represents the simulation results for the test loss level of the Corgi² algorithm, and a graph 1110 represents the simulation results for the test loss of SGD with the full shuffle.

For example, as shown in FIGS. 4-6, for the first experiment, the Corgi² algorithm significantly outperforms the CorgiPile algorithm.

For example, as shown by FIGS. 4-6, the Corgi² algorithm provides surprising results, which appear to be fully competitive with the full shuffle, e.g., in the more difficult task (ImageNet) (FIG. 5), and appear to struggle more in the simpler task (CIFAR-100) (FIG. 4).

This may have occurred as a result of using artificially small buffer ratios on a dataset that was not large to begin with.

For example, up to this point the specific task a learning model is trying to accomplish has not been considered, and the focus was put on the variance between blocks as a key metric. However, the CIFAR100 model is a classifier. For example, a dataset with an imbalanced weighting among classes, e.g., the data is not equally distributed among classes, may imposes additional challenges on the training process. For example, by limiting the buffer size to 0.2% on the CIFAR 100 model, one may end up with 100 examples per buffer, e.g., out of a total of 50000 in the train set. This may lead to a high variance of the weight balancing among classes, compounding on top of the usual increase in variance that the CorgiPile algorithm and the Corgi² algorithm impose. Although not quantified in either a theoretical or experimental manner, it is reasonable to expect that this would slow down the convergence rate, which is the phenomena observed in the results.

For example, while the Corgi² algorithm outperforms the CorgiPile algorithm in the next-token prediction task (FIG. 6) as well, the difference is less pronounced, and it does not catch up to Full Shuffle within 100 epochs.

For example, the performance results of the Corgi² algorithm and the CorgiPile algorithm, which may be closer to the performance of the full shuffle on the TextTile dataset, e.g., than the performance for the other datasets.

For example, the TextTile dataset may have data from 10 very different sources, distinct enough from each other to mimic the concept of classes in an image classifier. However, even in buffer sizes of 0.25%, each buffer includes hundreds of files, making it highly likely that the weight balancing between the types was fairly good, thus boosting the performance.

For example, as shown by FIGS. 7-9, the results of the second experiment are consistent with the theoretical findings that increasing the number n (for a fixed buffer size) accelerates convergence, e.g., as described above. The increase in the number n may result in a linear increase in Input/Output (IO) operations, e.g., as described above.

For example, as shown in FIGS. 10-11, the third experiment shows complete parity between the full shuffle and the Corgi² algorithm, e.g., in a real world setting.

It is noted, that in view of the results of the above experiments, the Corgi² algorithm has been successfully implemented and used in some infrastructure, leading to exceptional results, including speedups of three orders of magnitude in the offline shuffle phases for some models, as well as speeding up the online phase, all without negatively impacting performance.

In some demonstrative aspects, the dual-shuffling technique described herein, e.g., as implemented by the Corgi² algorithm, may be modified and/or adjusted for example, to provide a technical solution to support various purposes and/or use cases, e.g., as described below.

In some demonstrative aspects, the dual-shuffling technique described herein, e.g., as implemented by the Corgi² algorithm, may be modified and/or adjusted for example, to provide a technical solution to support repeated offline shuffles.

For example, the dual-shuffling technique described herein, e.g., as implemented by the Corgi² algorithm, may be configured to repeat the offline phase (2) multiple times, for example, to further reduce block variance before the online phase. For example, this configuration may incur a cost in query complexity, e.g., as outlined in Table (1). However, each such repetition would lower the parameter h_{D} with a factor of about n, e.g., according to Theorem 1, and consequently would improve the convergence rate, e.g., as described in Theorem 2.

For example, the magnitude of the reduction may diminish exponentially with each further repetition, while query complexity may increase linearly. In some scenarios this modification may be useful. In other scenarios, it may be more cost effective to boost performance, e.g., by increasing the number of blocks in the buffer.

In some demonstrative aspects, the dual-shuffling technique described herein, e.g., as implemented by the Corgi² algorithm, may be modified and/or adjusted for example, to provide a technical solution to support sampling without replacement.

For example, there may be a motivation for sampling with replacement in the Corgi² algorithm, for example, to streamline the theoretical analysis, despite understanding that sampling without replacement is preferred in real world applications, e.g., as described above. It is noted that, empirically, most experiments discussed above were repeated in both ways, with no discernible differences.

In some demonstrative aspects, the dual-shuffling technique described herein, e.g., as implemented by the Corgi² algorithm, may be modified and/or adjusted for example, to provide a technical solution to support overwriting blocks, e.g., to conserve storage.

For example, the OfflineCorgiShuffle Algorithm may be configured to delete each block it finishes reading, thus maintaining the number of blocks, e.g., as described above. For example, This modification may provide a technical solution to avoid doubling the storage requirements during execution of the Corgi² algorithm. It is noted that this modification may result in permanent data loss, e.g., unless combined with sampling without-replacement.

The following description includes proof relating to Variance, e.g., as used above for the Theorem 1.

The above discussion with reference to the Theorem 1, employs a generalization of scalar variance that can apply to vectors of arbitrary dimensions.

Let X∈ [symbol] ^{d} some random variable, and let μ= [symbol] [X], then:

$$V ( X ) = 𝔼 [ {‖ X - μ ‖}_{2} ] = 𝔼 [ {( X - μ )}^{T} ( X - μ ) ] \qquad ( 5 )$$

This representation of the variance may diverge from the more common definition of variance, e.g., as follows:

$$V ( X ) = V ( ( \begin{matrix}{x}_{1} \\ ⋮ \\ {x}_{n}\end{matrix} ) ) = 𝔼 [ ( X - μ ) {( X - μ )}^{T} ]$$

For example, the Equation (5) is a generalization of variance, e.g., in the sense that, when d=1, we get the standard variance definition for scalar random variables.

Following is proof of all properties of this measure of variance, which are used above with respect to the Theorem 1:

$$V ( X ) = 𝔼 [ {X}^{T} X ] - {μ}^{T} μ \qquad 1$$

$$\begin{matrix}V ( X ) = 𝔼 [ {( X - μ )}^{T} ( X - μ ) ] \\ = 𝔼 [ {X}^{T} X ] - 𝔼 [ {X}^{T} μ ] - 𝔼 [ {μ}^{T} X ] + {μ}^{T} μ \\ = 𝔼 [ {X}^{T} X ] - {μ}^{T} μ - {μ}^{T} μ + {μ}^{T} μ \\ = 𝔼 [ {X}^{T} X ] - {μ}^{T} μ\end{matrix}$$

$$V ( aX ) = {a}^{2} V ( X ) \qquad 2$$

$$\begin{matrix}V ( aX ) = 𝔼 [ {a ( X - μ )}^{T} a ( X - μ ) ] = {a}^{2} 𝔼 [ {( X - μ )}^{T} ( X - μ ) ] ) \\ = {a}^{2} V ( X )\end{matrix}$$

$$V ( X + Y ) = V ( X ) + V ( Y ) + COV ( X , Y ) + COV ( Y , X ) \qquad 3$$

Where COV(X, Y) is the cross covariance between X and Y, defined as:

$$\begin{matrix}𝔼 [ ( {( X - {μ}_{X} )}^{T} ( Y - {μ}_{Y} ) ] = ( V + Y ) \\ = 𝔼 [ [ {( X + Y - {μ}_{X} - {μ}_{Y} )}^{T} ( X + Y - {μ}_{X} - {μ}_{Y} ) ] \\ = 𝔼 [ {X}^{T} X - {X}^{T} {μ}_{X} - {μ}_{X}^{T} X + {μ}_{X}^{T} {μ}_{X} ] \\ + 𝔼 [ {Y}^{T} Y - {Y}^{T} {μ}_{Y} - {μ}_{Y}^{T} Y + {μ}_{Y}^{T} {μ}_{Y} ] \\ + 𝔼 [ {X}^{T} Y - {X}^{T} {μ}_{Y} - {μ}_{X}^{T} Y + {μ}_{X}^{T} {μ}_{Y} ] \\ + 𝔼 [ {Y}^{T} X - {Y}^{T} {μ}_{X} - {μ}_{Y}^{T} X + {μ}_{Y}^{T} {μ}_{X} ] \\ = 𝔼 [ {X}^{T} X ] - {μ}_{X}^{T} {μ}_{X} - {μ}_{X}^{T} {μ}_{X} + {μ}_{X}^{T} {μ}_{X} + 𝔼 [ {Y}^{T} Y ] \\ - {μ}_{Y}^{T} {μ}_{Y} - {μ}_{Y}^{T} {μ}_{Y} + {μ}_{Y}^{T} {μ}_{Y} + 𝔼 [ {( X - {μ}_{X} )}^{T} ( Y - {μ}_{Y} ) ] \\ + 𝔼 [ {( Y - {μ}_{Y} )}^{T} ( X - {μ}_{X} ) ] \\ = 𝔼 [ {X}^{T} X ] - {μ}_{X}^{T} {μ}_{X} + 𝔼 [ {YY}^{T} Y ] - {μ}_{Y}^{T} {μ}_{Y} \\ + CoV ( X , Y ) + Cov ( Y , X ) \\ = V ( X ) + V ( Y ) + Cov ( X , Y ) + Cov ( Y , X )\end{matrix}$$

$$V ( X ) = V ( 𝔼 [ X \vert Y ] ) + 𝔼 [ V ( X \vert Y ) ] ( Law Of Total Variance ) \qquad 4$$

$$First ,$$

$$\begin{matrix}𝔼 [ {X}^{T} X ] = 𝔼 [ 𝔼 [ {X}^{T} X \vert Y ] ] \\ = 𝔼 [ {X}^{T} X ] \\ = 𝔼 [ 𝔼 [ {X}^{T} X \vert Y ] - {𝔼}^{2} [ X \vert Y ] + {𝔼}^{2} [ X \vert Y ] ] \\ = 𝔼 [ V ( X \vert Y ) + {𝔼}^{2} [ X \vert Y ] ]\end{matrix}$$

Then,

$$\begin{matrix}V ( X ) = - {𝔼}^{2} [ X ] + 𝔼 [ {X}^{T} X ] \\ = - {𝔼}^{2} [ 𝔼 [ X \vert Y ] ] + 𝔼 [ {𝔼}^{2} [ X \vert Y ] + V ( X \vert Y ) ] \\ = - {𝔼}^{2} [ 𝔼 [ X \vert Y ] ] + 𝔼 [ {𝔼}^{2} [ X \vert Y ] ] + 𝔼 [ V ( X \vert Y ) ] \\ = V ( 𝔼 [ X \vert Y ] ) + 𝔼 [ V ( X \vert Y ) ]\end{matrix}$$

The following description includes a detailed proof of the Theorem 1.

Consider the execution of the OfflineCorgiShuffle algorithm on a dataset characterized by a variance bound σ², a block-wise gradient variance parameter h_{D}, N blocks containing b examples each, and a buffer size nb.

For all x, the following inequality holds:

$$𝔼 [ \frac{1}{N} {\sum }_{l = 1}^{N} {‖ ∇ {f}_{{\tilde{B}}_{l}} ( x ) - ∇ F ( x ) ‖}^{2} ] \leq {h}_{D}^{′} \frac{{σ}^{2}}{b} \qquad ( 6 )$$

wherein

$${h}_{D}^{′} = 1 + ( \frac{1}{n} - \frac{1}{nb} ) {h}_{D} ,$$

and ƒ_{\tilde{B}}_{ₗ}(x) denotes the average of examples in \tilde{B}ₗ, the l-th block generated by the OfflineCorgiShuffle algorithm.

First, we establish the following notations that will be used throughout the proof:
ƒᵢ, the loss of x over the i-th element of the dataset (for i∈[1, . . . , Nb], or simply “the i-th function”, ∇ƒᵢ.

$${B}_{i} = ( \begin{matrix}{f}_{ib} \\ ⋮ \\ {f}_{( i + 1 ) b - 1}\end{matrix} )$$

is the i-th block
ƒ_{B}_{ₗ}=Σ_{i=lb}^{b}(l+1)b is the average of functions in the l-th block.
For each of the N/n iteration of OfflineCorgi (Algorithm 2):

$$S = ( \begin{matrix}{B}_{{i}_{1}} \\ ⋮ \\ {B}_{{i}_{n}}\end{matrix} )$$

is a random vector composed of n uniform i.i.d selections of blocks, representing the input blocks for this iteration. Sᵢ is the i-th row of S, corresponding to a single function.

$${\tilde{B}}_{l} = ( \begin{matrix}{S}_{{i}_{1}} \\ ⋮ \\ {S}_{{i}_{b}}\end{matrix} )$$

is the l-th of n output blocks created this round, composed of b uniform i.i.d selections of rows from S.
ƒ_{\tilde{B}}_{ₗ} is the block average for output blocks, and ƒₛ is the average of the entire buffer of input blocks, defined similarly to ƒ_{B}_{ₗ} above.

Since for each iteration the r.v \tilde{B} is conditioned only on the value sampled for S in that iteration, and S is i.i.d between iterations, then \tilde{B} is also i.i.d between iterations.

Using the above notation, for an execution of the OfflineCorgiShuffle algorithm with a single iteration, we can rewrite the Theorem as:

$${V}_{S , \tilde{B} , j} ( ∇ {f}_{{\tilde{B}}_{j}} ) \leq {h}_{D}^{′} \frac{{σ}^{2}}{b}$$

wherein j is an index sampled uniformly from [1, . . . , n], and V is the generalized scalar variance discussed above. Since, as mentioned, the iterations are i.i.d, proving this is sufficient to prove the general case of Theorem 1. Using the law of total variance:

$$\frac{1}{N} {{\sum }^{N}}_{l = 1} {‖ ∇ {f}_{{\tilde{B}}_{l}} ( x ) - ∇ F ( x ) ‖}^{2} = {V}_{S , {\tilde{B}}_{l}} ( ∇ {f}_{{\tilde{B}}_{l}} ( x ) ) = {\underbrace{{V}_{S} ( {𝔼}_{{\tilde{B}}_{l}} [ ∇ {f}_{{\tilde{B}}_{l}} \vert S ] )}}_{( i )} + {\underbrace{{𝔼}_{S} [ {V}_{{\tilde{B}}_{l}} ( ∇ {f}_{{\tilde{B}}_{l}} \vert S ) ]}}_{( ii )}$$

(i):
when S is fixed, for any l in range \tilde{B}ₗ is a uniform i.i.d selection of b functions from S.

### Let

$$( \begin{matrix}{z}_{1} \\ ⋮ \\ {z}_{nb}\end{matrix} )$$

be a random vector s.t zᵢ is a random variable for the number of times Sᵢ has been selected in this process to a given \acute{B}.
Then \tilde{B}ₗ can be written as ZS, where Z is a diagonal matrix with Z_{i,i}=zᵢ.
The resulting r.v is a multinomial distribution with b experiments and nb possible results per experiment, each with an equal probability 1/nb. Thus:

$$\begin{matrix}{𝔼}_{{\tilde{B}}_{l}} [ ∇ {f}_{{\tilde{B}}_{l}} \vert S ] = ∇ ( \frac{1}{b} {\sum }_{i = 1}^{n b} {( {𝔼}_{Z} [ Z S ] )}_{i} ) \\ = ∇ ( \frac{1}{b} {\sum }_{i = 1}^{n b} 𝔼 [ {z}_{i} ] {S}_{i} ) = ∇ ( {\sum }_{i = 1}^{n b} \frac{1}{n} {S}_{i} ) \\ = ∇ ( \frac{1}{n b} {\sum }_{i = 1}^{n b} {s}_{i} ) = ∇ {f}_{S}\end{matrix}$$

We now have:

$${V}_{S} ( {𝔼}_{{\tilde{B}}_{l}} [ ∇ {f}_{{\tilde{B}}_{l}} \vert S ] ) = {V}_{S} ( ∇ {f}_{S} )$$

For a given

$$( \begin{matrix}{B}_{{i}_{1}} \\ ⋮ \\ {B}_{{i}_{n}}\end{matrix} ) ,$$

we have

$$∇ {f}_{S} = \frac{1}{n} {\sum }_{m = 1}^{n} ∇ {f}_{{B}_{{i}_{m}}}$$

where i₁, . . . , iₙ are the n blocks selected for S. Thus:

$${V}_{S} ( ∇ {f}_{S} ) = {V}_{S} ( \frac{1}{n} {\sum }_{m} ∇ {f}_{{B}_{{i}_{m}}} ) = \frac{1}{{n}^{2}} V ( {\sum }_{m} ∇ {f}_{{B}_{{i}_{m}}} ) \leq \frac{1}{n} {h}_{D} \frac{{σ}^{2}}{b}$$

where the inequality is due to the n block selections being i.i.d and the upper bound on block variance per assumption.
(ii):
Let i be a uniformly sampled index in the range [1, . . . , nb]. For a fixed S, define the sampling variance to be:

$$\begin{matrix}{V}_{i} ( {S}_{i} \vert S ) = {𝔼}_{i} [ {S}_{i}^{T} {S}_{i} ] - ∇ {f}_{S}^{T} ∇ {f}_{S} \\ = \frac{1}{n b} {\sum }_{i} 〈 {s}_{i} , {s}_{i} 〉 - \frac{1}{{( n b )}^{2}} ( {\sum }_{i} 〈 {s}_{i} , {s}_{i} 〉 + {\sum }_{i \neq j} 〈 {s}_{i} , {s}_{j} 〉 )\end{matrix}$$

This, in other words, is the variance of uniformly sampling a function from S.
We wish to find V(\tilde{B}|S). We define random variables as we did in (i) and apply Bienaymé's identity:

$$\begin{matrix}{V}_{i} ( ∇ {f}_{} \vert S ) = \frac{1}{{b}^{2}} V ( {\sum }_{i = 1}^{n b} {z}_{i} {s}_{i} ) \\ = \frac{1}{{b}^{2}} ( {\sum }_{i} V ( {z}_{i} ) 〈 {s}_{i} , {s}_{i} 〉 + {\sum }_{i \neq j} COV ( {z}_{i} , {z}_{j} ) 〈 {s}_{i} , {s}_{j} 〉 ) \\ = \frac{1}{{b}^{2}} ( {\sum }_{i} b \frac{1}{n b} ( 1 - \frac{1}{n b} ) 〈 {s}_{i} , {s}_{i} 〉 + {\sum }_{i \neq j} ( - \frac{b}{{n}^{2} {b}^{2}} ) 〈 {s}_{i} , {s}_{j} 〉 ) \\ = \frac{1}{{b}^{2}} ( {\sum }_{i} \frac{1}{n} 〈 {s}_{i} , {s}_{i} 〉 - {\sum }_{i} \frac{1}{{n}^{2} b} 〈 {s}_{i} , {s}_{j} 〉 - {\sum }_{i \neq j} \frac{1}{{n}^{2} b} 〈 {s}_{i} , {s}_{j} 〉 ) \\ = \frac{1}{b} ( \frac{1}{n b} {\sum }_{i} 〈 {s}_{i} , {s}_{i} 〉 - \frac{1}{{n}^{2} {b}^{2}} ( {\sum }_{i} 〈 {s}_{i} , {s}_{i} 〉 + {\sum }_{i \neq j} 〈 {s}_{i} , {s}_{j} 〉 ) ) \\ = \frac{1}{b} {V}_{i} ( {S}_{i} \vert S )\end{matrix}$$

We now have:

$${𝔼}_{S} [ {V}_{{\tilde{B}}_{l}} ( ∇ {f}_{{\tilde{B}}_{l}} \vert S ) ] = \frac{1}{b} {𝔼}_{S} [ {V}_{i} ( {S}_{i} \vert s ) ]$$

We further decompose this expression by a second application of the law of total variance:

$${𝔼}_{S} [ {V}_{i} ( {S}_{i} ) \vert S ] = {\underbrace{{V}_{i} ( {S}_{i} )}}_{I} - {\underbrace{{V}_{S} ( {𝔼}_{i} [ {S}_{i} \vert S ] )}}_{II}$$

With respect to the component II: [symbol] ᵢ[Sᵢ|S] is the expected value of sampling a function from a fixed S, which is simply ∇ƒ_{S}. Duplicating the calculation done for (i),

$${V}_{S} ( ∇ {f}_{S} ) \leq {h}_{D} \frac{{σ}^{2}}{b} .$$

With respect to the component I: when S is not fixed, it is a uniform i.i.d selection of blocks for [B₁, . . . , B_{N}]. Let

$$( \begin{matrix}{z}_{1} \\ ⋮ \\ {z}_{N}\end{matrix} )$$

be a random vector s.t zᵢ is a random variable for the number of times Bᵢ has been selected by this process for a given S. Then S can be written as ZB where Z is a diagonal matrix with Z_{i,i}=zᵢ, and

$$B = ( \begin{matrix}{B}_{1} \\ ⋮ \\ {B}_{N}\end{matrix} ) .$$

Since S is a multinomial with n experiments and N possible results with probability 1/N,

$$∀ i , k \geq 0 Pr ( {z}_{i} = k ) = ( \begin{matrix}n \\ k\end{matrix} ) {( \frac{1}{N} )}^{k} {( \frac{N - 1}{N} )}^{n - k}$$

Let ƒ be any function in some block Bⱼ. Then:

$$\begin{matrix}Pr ( {S}_{i} = f ) = {\sum }_{k = 1}^{n} P r ( {S}_{i} = f \vert {z}_{j} = k ) P r ( {z}_{j} = k ) \\ = {\sum }_{k = 1}^{n} ( \begin{matrix}n \\ k\end{matrix} ) {( \frac{1}{N} )}^{k} {( \frac{N - 1}{N} )}^{n - k} \frac{k}{n b} \\ = \frac{1}{n b} {\sum }_{k = 1}^{n} ( \begin{matrix}n \\ k\end{matrix} ) {( \frac{1}{N} )}^{k} {( \frac{N - 1}{N} )}^{n - k} k = \\ = \frac{1}{n b} 𝔼 [ {z}_{i} ] = \frac{1}{n b} \frac{n}{N} = \frac{1}{N b}\end{matrix}$$

It may be observed that a sample from S has the same distribution as a sample from the dataset itself, which, as previously mentioned, is bound by σ².

### Overall we get

$${𝔼}_{S} [ {V}_{{\tilde{B}}_{l}} ( ∇ {f}_{{\tilde{B}}_{l}} \vert S ) ] = \frac{1}{b} {𝔼}_{S} [ {V}_{i} ( {S}_{i} \vert s ) ] \leq \frac{1}{b} ( {σ}^{2} + \frac{1}{n} {h}_{D} \frac{{σ}^{2}}{b} )$$

And the variance reduction of Theorem 1 is achieved by plugging in the components (i) and (ii).

The following description includes a detailed proof of the Theorem 2.

Suppose that F(x) are smooth and u-strongly convex functions. Let T= [symbol] nb be the total number of examples seen during training, where [symbol] ≥1 is the number of buffers iterated.

Choose the learning rate to be

$${η}_{t} = \frac{6}{b n μ ( t + a )} ,$$

where

$$a \geq max \{ \frac{8 L G + 24 {L}^{2} + 28 {L}_{H} G}{{μ}^{2}} , \frac{24 L}{μ} \} .$$

Then, the Corgi² algorithm may have the following convergence rate in the online stage, e.g., for any choice of x₀,

$$𝔼 [ F ( {\overline{x}}_{𝒯} ) - F ( {x}^{*} ) ] \leq ( 1 - α ) {h}_{D}^{′} {σ}^{2} \frac{1}{T} + β \frac{1}{{T}^{2}} + γ \frac{{( Nb )}^{3}}{{T}^{3}} , \qquad ( 7 )$$

where

$${\overline{x}}_{𝒯} = \frac{{Σ}_{t} {( t + a )}^{3} {x}_{t}}{{Σ}_{t} {( t + a )}^{3}} ,$$

and

$$α := \frac{n - 1}{N - 1} , β := {α}^{2} + {( 1 - α )}^{2} {( b - 1 )}^{2} , γ := \frac{{n}^{3}}{{N}^{3}} .$$

Our proof is not a complete derivation of the convergence rate, but rather an application of the variance reduction obtained in Theorem 1 to the existing convergence rate derived for the CorgiPile algorithm.

Since the online phase of the Corgi² algorithm may be implemented to be similar to the CorgiPile algorithm, e.g., as described above, most of the logic used in deriving the convergence rate for CorgiPile algorithm may also be applicable for the Corgi² algorithm.

However, in the CorgiPile algorithm the dataset itself is non stochastic, while the Corgi² algorithm may generate the dataset in the offline phase, thereby introducing new randomness.

For example, the CorgiPile algorithm nay have the following convergence rate:

$${𝔼}_{C o g i P i l e} [ F ( {\overline{x}}_{𝒯} ) - F ( {x}^{*} ) ] \leq ( 1 - α ) {h}_{D} {σ}^{2} \frac{1}{T} + β \frac{1}{{T}^{2}} + γ \frac{{( N b )}^{3}}{{T}^{3}}$$

For example, the Corgi² algorithm may be seen as taking the expected value over the offline randomness, e.g., as follows:

$${𝔼}_{OfflineCorgiShuffle} [ {𝔼}_{CogiPile} [ F ( {\overline{x}}_{𝒯} ) - F ( {x}^{*} ) ] ] \leq ? \qquad ( 8 )$$

For example, the following proof does not provide a comprehensive reconstruction of the proof for the CorgiPile convergence rate, for example, because the majority of steps in that proof may remain unaffected when encapsulated within a new expectation expression. Consequently, the subsequent section of this proof will refer directly to sections in the CorgiPile convergence rate proof without providing complete statements here.

One observation to note is that the assumptions from the CorgiPile convergence rate proof impose upper bounds on properties of all individual or pairs of samples from the dataset.

Given that the OfflineCorgiShuffle algorithm may output a subset (with repetitions) of the original dataset, these assumptions may be ensured to remain valid. For this reason, any step in the CorgiPile proof which replaces an expression with L, G or H may work as-is for the proof with respect to the Corgi² algorithm.

For example, the CorgiPile proof begins by taking a known upper bound on [symbol] _{CorgiPile} [∥X₀^{t+1}−X*∥²], and derives the following inequality from it:

$${\underbrace{{η}_{t} b n ( F ( {X}_{0}^{t} ) - F ( {X}^{*} ) )}}_{I} \leq {\underbrace{( 1 - \frac{1}{2} {η}_{t} bnμ ) {‖ {X}_{0}^{t} - {X}^{*} ‖}^{2} - 𝔼 [ {‖ {X}_{0}^{t + 1} - {X}^{*} ‖}^{2} ]}}_{II} + {\underbrace{{C}_{2} {η}_{t}^{2} n b \frac{N - n}{N - 1} {h}_{D} {σ}^{2}}}_{III} + {\underbrace{C 3 {η}_{t}^{3} b n [ {( \frac{N - n}{N - 1} )}^{2} {( b - 1 )}^{2} + {( \frac{N - 1}{N - 1} )}^{2} ] + {C}_{4} {η}_{t}^{4} {b}^{4} {n}^{4}}}_{IV}$$

It is noted that we deviate slightly from the original notation by using t to denote the round number instead of s. Additionally, we'll use [symbol] _{S,\tilde{B}}[ ] to express taking an expected value over the randomness of the OfflineCorgiShuffle algorithm.

For example, taking the expectation over the OfflineCorgiShuffle algorithm randomness on both sides of this inequality has the following effects:

$${𝔼}_{S , \tilde{B}} [ {η}_{t} b n ( F ( {X}_{0}^{t} ) - F ( {X}^{*} ) ) ] = {η}_{t} bn {𝔼}_{S , \tilde{B}} [ ( F ( {X}_{0}^{t} ) - F ( {X}^{*} ) ) ] \qquad I$$

$${𝔼}_{S , \tilde{B}} [ ( 1 - \frac{1}{2} {η}_{t} bn μ ) {‖ {X}_{0}^{t} - {X}^{*} ‖}^{2} - 𝔼 [ {‖ {X}_{0}^{t + 1} - {X}^{*} ‖}^{2} ] ] = ( 1 - \frac{1}{2} {η}_{t} bnμ ) {𝔼}_{S , \tilde{B}} [ {‖ {X}_{0}^{t} - {X}^{*} ‖}^{2} ] - {𝔼}_{S , \tilde{B}} [ 𝔼 [ {‖ {X}_{0}^{t + 1} - {X}^{*} ‖}^{2} ] ] \qquad II$$

III—see discussion below

$${𝔼}_{S \tilde{B}} [ C 3 {η}_{t}^{3} b n [ {( \frac{N - n}{N - 1} )}^{2} {( b - 1 )}^{2} + {( \frac{N - 1}{N - 1} )}^{2} ] + {C}_{4} {η}_{t}^{4} {b}^{4} {n}^{4} ] = C 3 {η}_{t}^{3} b n [ {( \frac{N - n}{N - 1} )}^{2} {( b - 1 )}^{2} + {( \frac{N - 1}{N - 1} )}^{2} ] + {C}_{4} {η}_{t}^{4} {b}^{4} {n}^{4} \qquad IV$$

For example, with respect to the point III, both h_{D} and σ² cannot be treated as constants in the context of [symbol] _{S,\tilde{B}}[⋅]. σ² is affected by the OfflineCorgiShuffle algorithm, e.g., because the relating dataset is a subset (potentially with repetitions) of the original, and thus may have a different variance. h_{D} is affected because the new blocks are not guaranteed to have the same blockwise variance. For example, changing h_{D} may be an important, e.g., primary, gain of the OfflineCorgiShuffle algorithm.

For example, in order to apply the expectation on this component, we recall that it is an upper bound, introduced in equation (10) (as part of calculating I₄) of the CorgiPile proof:

$$\begin{matrix}{I}_{4} = 2 {η}_{t}^{2} 𝔼 [ {‖ {\sum }_{k = 1}^{b n} ∇ {f}_{{Ψ}_{t} ( k )} - 𝔼 [ {\sum }_{k = 1}^{b n} ∇ {f}_{{Ψ}_{t} ( k )} ‖}^{2} ] \\ = \frac{n ( N - n )}{N - 1} {𝔼}_{j} [ {‖ ∇ {f}_{{B}_{j}} ( {X}_{0}^{t} ) - b ∇ F ( {X}_{0}^{t} ) ‖}^{2} ] \leq s {η}_{s}^{2} \frac{n b ( N - n )}{N - 1} {h}_{D} {σ}^{2}\end{matrix}$$

For example, we can apply the expectation over I₄, and obtain a new inequality by applying Theorem 1, e.g., as follows:

$${𝔼}_{S , \tilde{B}} [ \frac{n ( N - n )}{N - 1} {𝔼}_{j} [ {‖ ∇ {f}_{{B}_{j}} ( {X}_{0}^{t} ) - b ∇ F ( {X}_{0}^{r} ) ‖}^{2} ] ] = \frac{n ( N - n )}{N - 1} {𝔼}_{S , \tilde{B}} [ {𝔼}_{j} [ {‖ ∇ {f}_{{B}_{j}} ( {X}_{0}^{t} ) - b ∇ F ( {X}_{0}^{t} ) ‖}^{2} ] ] \leq \frac{n ( N - n )}{N - 1} {h}_{D}^{′} \frac{{σ}^{2}}{b}$$

For example, we may substitute III with

$${C}_{2} {η}_{s}^{2} n b \frac{N - n}{N - 1} {h}_{D}^{′} {σ}^{2} .$$

All in all we obtain:

$${η}_{s} bn {𝔼}_{S , \tilde{B}} [ ( F ( {X}_{0}^{t} ) - F ( {X}^{*} ) ) ] \leq ( 1 - \frac{1}{2} {η}_{S} bn μ ) {𝔼}_{S , \tilde{B}} [ {‖ {X}_{0}^{t} - {X}^{*} ‖}^{2} ] - {𝔼}_{S , \tilde{B}} [ 𝔼 [ {‖ {X}_{0}^{t + 1} - {X}^{*} ‖}^{2} ] ] + {C}_{2} {η}_{t}^{2} n b \frac{N - n}{N - 1} {h}_{D}^{′} {σ}^{2} + C 3 {η}_{t}^{3} b n [ {( \frac{N - n}{N - 1} )}^{2} {( b - 1 )}^{2} + {( \frac{N - 1}{N - 1} )}^{2} ] + {C}_{4} {η}_{t}^{4} {b}^{4} {n}^{4}$$

For example, the CorgiPile proof proceeds by applying a lemma (lemma 3) where series a is {(F(X₀^{t})−F(X*))}, and series b is {∥X₀^{t}−X*∥²}. For example, in our case, [symbol] _{S,\tilde{B}}[(F(X₀^{t})−F(X*))] and [symbol] _{S,\tilde{B}}[∥X₀^{t}−X*∥²] can be used as seamless replacements.

For example, from this point forward no additional modifications of the CorgiPile proof may be required, for example, to arrive at the convergence rate described in Theorem 2.

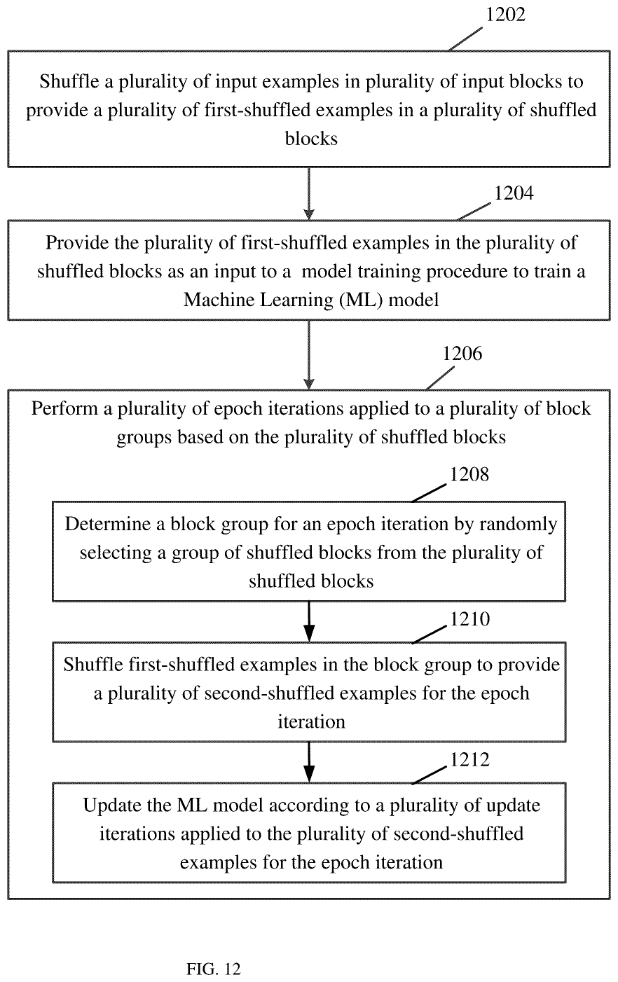

Reference is made to FIG. 12, which schematically illustrates a method of ML model training, in accordance with some demonstrative aspects. For example, one or more of the operations of the method of FIG. 12 may be performed by one or more elements of a system, e.g., system 100 (FIG. 1), for example, one or more elements of a ML model training system, e.g., ML model training system 110 (FIG. 1), for example, one or more processors, e.g., one or more processors 112 (FIG. 1).

As indicated at block, 1202, the method may include shuffling a plurality of input examples in plurality of input blocks to provide a plurality of first-shuffled examples in a plurality of shuffled blocks. For example, first shuffler 120 (FIG. 1) may be configured to shuffle the plurality of input examples in the plurality of input blocks to provide the plurality of first-shuffled examples in the plurality of shuffled blocks, e.g., as described above.

As indicated at block 1204, the method may include providing the plurality of first-shuffled examples in the plurality of shuffled blocks as an input to a model training procedure to train an ML model. For example, first shuffler 120 (FIG. 1) may be configured to provide the plurality of first-shuffled examples in the plurality of shuffled blocks as an input to the ML model training procedure 130 (FIG. 1), e.g., as described above.

As indicated at block 1206, the method may include performing a plurality of epoch iterations applied to a plurality of block groups based on the plurality of shuffled blocks. For example, ML model training procedure 130 (FIG. 1) may be configured to perform the plurality of epoch iterations applied to the plurality of block groups based on the plurality of shuffled blocks, e.g., as described above.

As indicated at block 1208, performing the plurality of epoch iterations may include determining a block group for an epoch iteration by randomly selecting a group of shuffled blocks from the plurality of shuffled blocks. For example, second shuffler 132 (FIG. 1) may be configured to determine the block group for the epoch iteration by randomly selecting the group of shuffled blocks from the plurality of shuffled blocks, e.g., as described above.

As indicated at block 1210, performing the plurality of epoch iterations may include shuffling first-shuffled examples in the block group to provide a plurality of second-shuffled examples for the epoch iteration. For example, second shuffler 132 (FIG. 1) may be configured to shuffle the first-shuffled examples in the block group to provide the plurality of second-shuffled examples for the epoch iteration, e.g., as described above.

As indicated at block 1212, performing the plurality of epoch iterations may include updating the ML model according to a plurality of update iterations applied to the plurality of second-shuffled examples for the epoch iteration. For example, model update procedure 134 (FIG. 1) may be configured to update the ML model according to the plurality of update iterations applied to the plurality of second-shuffled examples for the epoch iteration, e.g., as described above.

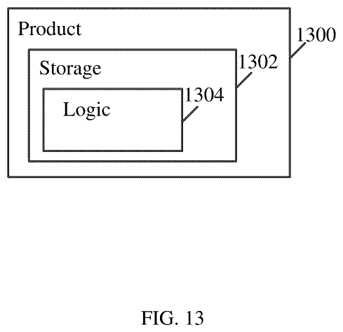

Reference is made to FIG. 13, which schematically illustrates a product of manufacture 1300, in accordance with some demonstrative aspects. Product 1300 may include one or more tangible computer-readable (“machine-readable”) non-transitory storage media 1302, which may include computer-executable instructions, e.g., implemented by logic 1304, operable to, when executed by at least one computer processor, enable the at least one computer processor to implement one or more operations at ML model training system 110 (FIG. 1), processors 112 (FIG. 1), first shuffler 120 (FIG. 1), ML model training procedure 130 (FIG. 1), second shuffler 132 (FIG. 1), and/or model update procedure 134 (FIG. 1); to cause ML model training system 110 (FIG. 1), processors 112 (FIG. 1), first shuffler 120 (FIG. 1), ML model training procedure 130 (FIG. 1), second shuffler 132 (FIG. 1), and/or model update procedure 134 (FIG. 1) to perform, trigger and/or implement one or more operations and/or functionalities; and/or to perform, trigger and/or implement one or more operations and/or functionalities described with reference to the FIGS. 1-12, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 1300 and/or machine readable storage media 1302 may include one or more types of computer-readable storage media capable of storing data, including volatile memory, non-volatile memory, removable or non-removable memory, erasable or non-erasable memory, writeable or re-writeable memory, and the like. For example, machine readable storage media 1302 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 1304 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 1304 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes a product comprising one or more tangible computer-readable non-transitory storage media comprising instructions operable to, when executed by at least one processor, enable the at least one processor to cause a Machine-Learning (ML) model training system to shuffle a plurality of input examples in plurality of input blocks to provide a plurality of first-shuffled examples in a plurality of shuffled blocks; and provide the plurality of first-shuffled examples in the plurality of shuffled blocks as an input to a model training procedure to train an ML model, the model training procedure comprising a plurality of epoch iterations applied to a plurality of block groups, wherein an epoch iteration of the plurality of epoch iterations comprises determining a block group for the epoch iteration by randomly selecting a group of shuffled blocks from the plurality of shuffled blocks; shuffling first-shuffled examples in the block group to provide a plurality of second-shuffled examples; and updating the ML model according to a plurality of update iterations applied to the plurality of second-shuffled examples.

Example 2 includes the subject matter of Example 1, and optionally, wherein the instructions, when executed, cause the ML model training system to shuffle the plurality of input examples in the plurality of input blocks by shuffling input examples in a plurality of input block groups.

Example 3 includes the subject matter of Example 2, and optionally, wherein a count of input blocks in an input block group of the plurality of input block groups is equal to a count of shuffled blocks in the group of shuffled blocks.

Example 4 includes the subject matter of any one of Examples 1-3, and optionally, wherein the instructions, when executed, cause the ML model training system to shuffle the plurality of input examples in the plurality of input blocks according to a plurality of shuffling iterations applied to a plurality of input block groups, wherein a shuffling iteration of the plurality of shuffling iterations comprises determining an input block group for the shuffling iteration by randomly selecting a group of input blocks from the plurality of input blocks; and randomly assigning input examples from the input block group as first-shuffled examples in a group of shuffled blocks.

Example 5 includes the subject matter of Example 4, and optionally, wherein the instructions, when executed, cause the ML model training system to randomly assign input examples from the input block group in a plurality of assignment iterations, wherein an assignment iteration comprises randomly selecting a plurality of input examples from the input block group and assigning the plurality of input examples to a shuffled block.

Example 6 includes the subject matter of Example 5, and optionally, wherein the instructions, when executed, cause the ML model training system to randomly select the plurality of input examples from the input block group according to an Independent and Identically Distributed (IID) sampling with replacement.

Example 7 includes the subject matter of any one of Examples 4-6, and optionally, wherein a count of input blocks in the group of input blocks is equal to a count of shuffled blocks in the group of shuffled blocks.

Example 8 includes the subject matter of any one of Examples 4-7, and optionally, wherein a count of the shuffling iterations is based on a count of input blocks in the plurality of input blocks, and a count of input blocks in the group of input blocks.

Example 9 includes the subject matter of any one of Examples 4-8, and optionally, wherein the instructions, when executed, cause the ML model training system to randomly select the group of input blocks according to an Independent and Identically Distributed (IID) sampling with replacement.

Example 10 includes the subject matter of any one of Examples 1-9, and optionally, wherein the instructions, when executed, cause the ML model training system to perform a before-training shuffling to provide the plurality of first-shuffled examples in the plurality of shuffled blocks, and to perform a during-training shuffling of the plurality of first-shuffled examples during the model training procedure subsequent to the before-training shuffling.

Example 11 includes the subject matter of Example 10, and optionally, wherein the instructions, when executed, cause the ML model training system to perform the before-training shuffling on an entire dataset of the plurality of input examples to be used for the model training procedure.

Example 12 includes the subject matter of any one of Examples 1-11, and optionally, wherein the model training procedure comprises a Stochastic Gradient Descent (SGD) based (SGD-based) training procedure.

Example 13 includes the subject matter of Example 12, and optionally, wherein an update iteration of the plurality of update iterations comprises updating the ML model based on a gradient of an optimization function applied to a second-shuffled example of the plurality of second-shuffled examples.

Example 14 includes the subject matter of any one of Examples 1-13, and optionally, wherein a count of first-shuffled examples in a shuffled block of the plurality of shuffled blocks is equal to a count of input examples in an input block of the plurality of input blocks.

Example 15 includes the subject matter of any one of Examples 1-14, and optionally, wherein a count of shuffled blocks in the plurality of shuffled blocks is equal to a count of input blocks in the plurality of input blocks.

Example 16 includes the subject matter of Example 1-15, and optionally, wherein the instructions, when executed, cause the ML model training system to randomly select the group of shuffled blocks from the plurality of shuffled blocks according to an Independent and Identically Distributed (IID) sampling without replacement.

Example 17 includes the subject matter of any one of Examples 1-16, and optionally, wherein the instructions, when executed, cause the ML model training system to sequentially retrieve the plurality of input blocks from at least one storage.

Example 18 includes a Machine-Learning (ML) model training system comprising one or more memories having stored thereon instructions; and one or more processors to execute the instructions to cause the ML model training system to shuffle a plurality of input examples in plurality of input blocks to provide a plurality of first-shuffled examples in a plurality of shuffled blocks; and provide the plurality of first-shuffled examples in the plurality of shuffled blocks as an input to a model training procedure to train an ML model, the model training procedure comprising a plurality of epoch iterations applied to a plurality of block groups, wherein an epoch iteration of the plurality of epoch iterations comprises determining a block group for the epoch iteration by randomly selecting a group of shuffled blocks from the plurality of shuffled blocks; shuffling first-shuffled examples in the block group to provide a plurality of second-shuffled examples; and updating the ML model according to a plurality of update iterations applied to the plurality of second-shuffled examples.

Example 19 includes the subject matter of Example 18, and optionally, comprising subject matter of any of Examples 1-17.

Example 20 includes a system comprising means for performing any of the described operations of any of Examples 1-17.

Example 21 includes a method comprising any of the described operations of any one of Examples 1-17.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. A product comprising one or more tangible computer-readable non-transitory storage media comprising instructions operable to, when executed by at least one processor, enable the at least one processor to cause a Machine-Learning (ML) model training system to:
shuffle a plurality of input examples in plurality of input blocks to provide a plurality of first-shuffled examples in a plurality of shuffled blocks; and
provide the plurality of first-shuffled examples in the plurality of shuffled blocks as an input to a model training procedure to train an ML model, the model training procedure comprising a plurality of epoch iterations applied to a plurality of block groups, wherein an epoch iteration of the plurality of epoch iterations comprises:
determining a block group for the epoch iteration by randomly selecting a group of shuffled blocks from the plurality of shuffled blocks;
shuffling first-shuffled examples in the block group to provide a plurality of second-shuffled examples; and
updating the ML model according to a plurality of update iterations applied to the plurality of second-shuffled examples.

2. The product of claim 1, wherein the instructions, when executed, cause the ML model training system to shuffle the plurality of input examples in the plurality of input blocks by shuffling input examples in a plurality of input block groups.

3. The product of claim 2, wherein a count of input blocks in an input block group of the plurality of input block groups is equal to a count of shuffled blocks in the group of shuffled blocks.

4. The product of claim 1, wherein the instructions, when executed, cause the ML model training system to shuffle the plurality of input examples in the plurality of input blocks according to a plurality of shuffling iterations applied to a plurality of input block groups, wherein a shuffling iteration of the plurality of shuffling iterations comprises:
determining an input block group for the shuffling iteration by randomly selecting a group of input blocks from the plurality of input blocks; and
randomly assigning input examples from the input block group as first-shuffled examples in a group of shuffled blocks.

5. The product of claim 4, wherein the instructions, when executed, cause the ML model training system to randomly assign input examples from the input block group in a plurality of assignment iterations, wherein an assignment iteration comprises randomly selecting a plurality of input examples from the input block group and assigning the plurality of input examples to a shuffled block.

6. The product of claim 5, wherein the instructions, when executed, cause the ML model training system to randomly select the plurality of input examples from the input block group according to an Independent and Identically Distributed (IID) sampling with replacement.

7. The product of claim 4, wherein a count of input blocks in the group of input blocks is equal to a count of shuffled blocks in the group of shuffled blocks.

8. The product of claim 4, wherein a count of the shuffling iterations is based on a count of input blocks in the plurality of input blocks, and a count of input blocks in the group of input blocks.

9. The product of claim 4, wherein the instructions, when executed, cause the ML model training system to randomly select the group of input blocks according to an Independent and Identically Distributed (IID) sampling with replacement.

10. The product of claim 1, wherein the instructions, when executed, cause the ML model training system to perform a before-training shuffling to provide the plurality of first-shuffled examples in the plurality of shuffled blocks, and to perform a during-training shuffling of the plurality of first-shuffled examples during the model training procedure subsequent to the before-training shuffling.

11. The product of claim 10, wherein the instructions, when executed, cause the ML model training system to perform the before-training shuffling on an entire dataset of the plurality of input examples to be used for the model training procedure.

12. The product of claim 1, wherein the model training procedure comprises a Stochastic Gradient Descent (SGD) based (SGD-based) training procedure.

13. The product of claim 12, wherein an update iteration of the plurality of update iterations comprises updating the ML model based on a gradient of an optimization function applied to a second-shuffled example of the plurality of second-shuffled examples.

14. The product of claim 1, wherein a count of first-shuffled examples in a shuffled block of the plurality of shuffled blocks is equal to a count of input examples in an input block of the plurality of input blocks.

15. The product of claim 1, wherein a count of shuffled blocks in the plurality of shuffled blocks is equal to a count of input blocks in the plurality of input blocks.

16. The product of claim 1, wherein the instructions, when executed, cause the ML model training system to randomly select the group of shuffled blocks from the plurality of shuffled blocks according to an Independent and Identically Distributed (IID) sampling without replacement.

17. The product of claim 1, wherein the instructions, when executed, cause the ML model training system to sequentially retrieve the plurality of input blocks from at least one storage.

18. A Machine-Learning (ML) model training system comprising:
one or more memories having stored thereon instructions; and
one or more processors to execute the instructions to cause the ML model training system to:
shuffle a plurality of input examples in plurality of input blocks to provide a plurality of first-shuffled examples in a plurality of shuffled blocks; and
provide the plurality of first-shuffled examples in the plurality of shuffled blocks as an input to a model training procedure to train an ML model, the model training procedure comprising a plurality of epoch iterations applied to a plurality of block groups, wherein an epoch iteration of the plurality of epoch iterations comprises:
determining a block group for the epoch iteration by randomly selecting a group of shuffled blocks from the plurality of shuffled blocks;
shuffling first-shuffled examples in the block group to provide a plurality of second-shuffled examples; and
updating the ML model according to a plurality of update iterations applied to the plurality of second-shuffled examples.

19. The ML model training system of claim 18, wherein the one or more processors are configured to execute the instructions to cause the ML model training system to shuffle the plurality of input examples in the plurality of input blocks according to a plurality of shuffling iterations applied to a plurality of input block groups, wherein a shuffling iteration of the plurality of shuffling iterations comprises:
determining an input block group for the shuffling iteration by randomly selecting a group of input blocks from the plurality of input blocks; and
randomly assigning input examples from the input block group as first-shuffled examples in a group of shuffled blocks.

20. The ML model training system of claim 18, wherein the one or more processors are configured to execute the instructions to cause the ML model training system to perform a before-training shuffling to provide the plurality of first-shuffled examples in the plurality of shuffled blocks, and to perform a during-training shuffling of the plurality of first-shuffled examples during the model training procedure subsequent to the before-training shuffling.

21. A method of Machine-Learning (ML) model training, the method comprising:
shuffling a plurality of input examples in plurality of input blocks to provide a plurality of first-shuffled examples in a plurality of shuffled blocks; and
providing the plurality of first-shuffled examples in the plurality of shuffled blocks as an input to a model training procedure to train an ML model, the model training procedure comprising a plurality of epoch iterations applied to a plurality of block groups, wherein an epoch iteration of the plurality of epoch iterations comprises:
determining a block group for the epoch iteration by randomly selecting a group of shuffled blocks from the plurality of shuffled blocks;
shuffling first-shuffled examples in the block group to provide a plurality of second-shuffled examples; and
updating the ML model according to a plurality of update iterations applied to the plurality of second-shuffled examples.

22. The method of claim 21 comprising shuffling the plurality of input examples in the plurality of input blocks according to a plurality of shuffling iterations applied to a plurality of input block groups, wherein a shuffling iteration of the plurality of shuffling iterations comprises:
determining an input block group for the shuffling iteration by randomly selecting a group of input blocks from the plurality of input blocks; and
randomly assigning input examples from the input block group as first-shuffled examples in a group of shuffled blocks.
